(19) United States
(12) Patent Application Publication
(10) Pub. No.: US 2008/0133921 A1
(43) Pub. Date: Jun. 5, 2008

(54) Message authentication system and message authentication method

(75) Inventor: Taketsugu Yao, Tokyo (JP)

Correspondence Address: RABIN & Berdo, PC, 1101 14TH STREET, NW, SUITE 500, WASHINGTON, DC, 20005, US

(73) Assignee: OKI ELECTRIC INDUSTRY CO., LTD., Tokyo (JP)

(21) Appl. No.: 11/976,374

(22) Filed: Oct. 24, 2007

(30) Foreign Application Priority Data
Nov. 30, 2006 (JP) JP2006-324059

(51) Int. Cl. H04L 9/06

(52) U.S. Cl. 713/175

(57) ABSTRACT

This invention provides a message authentication system including: a message sending device having a send notice information generating unit that generates a first authentication code to certify a message and a second authentication code to certify the first authentication code and that sends the message and an authentication code generation key after authenticating reception certification information for the send notice information from a message receiving device; and including the message receiving device having a reception certification information generating unit that generates the reception certification information to certify the receiving of the send notice information, a first authentication code authenticating unit that authenticates the first authentication code by using the second authentication code and the authentication code generation key, a message authenticating unit that authenticates the message by using the authenticated first authentication code and the authentication code generation key. Thereby, the data capacity held by a node can be reduced.

### CROSS-REFERENCE TO RELATED APPLICATION

The disclosure of Japanese Patent Application No. JP2006-324059 filed on Nov. 30, 2006, entitled “MESSAGE AUTHENTICATION SYSTEM AND MESSAGE AUTHENTICATION METHOD”. The contents of that application are incorporated herein by reference in their entirety.

### BACKGROUND OF THE INVENTION

The present invention relates to a message authentication system and a message authentication method.

### DESCRIPTION OF THE RELATED ART

In recent years, there has been developed a sensor network system collecting and managing information wirelessly by using numerous sensors having a small wireless communication device built-in. For example, there is proposed the applications to various fields such as plant management for facilities such as factory, management of security/fire-prevention equipment in building or house, observation of environment, etc. The sensor network system is configured by a server managing and controlling the whole system and numerous sensor nodes developed at low cost. The server sends a message to the sensor nodes and the nodes authenticates that the received message is sent from the server. In such a sensor network system, a communication between the server and the node is generally achieved by multihop communication form transmitting data through a plurality of nodes relaying the data.

Since the node in the sensor network system is required to be low cost, a device equipped with a CPU and so on with high processing capabilities or a highly-tamper-resistant device is not necessarily used. Therefore, for adopting a method of public key cryptosystem in message authentication, the processing load on CPU may become too large, and it is desirable to adopt a common key cryptosystem with small processing load. For example, this corresponds to the method of authenticating a message from the server by giving the common key for all devices to the server and all nodes. However, when the high-tamper-resistance of the nodes cannot be ensured, the common key for all devices stored in the nodes may be leaked. For this reason, even the message with successful authentication may be an incorrect message populated by an attacker by message insertion attack (Node Compromise Attack). Or, there is a possibility of being the message tampered with by an incorrect router node halfway through the relay of multihop communication (Node Replication Attack).

In Japanese Patent Laid-open Publication No. 2006-157856 (hereafter, referred to as Patent Document 1) and written by Adrian Perrig, J. D. Tyger, translation supervisor Fumio Mizoguchi, wired/wireless network ni okeru broadcast tsuushinn no security, KYORITSU SHUPPAN CO., LTD pp. 172-177 (hereafter, referred to as Nonpatent Literature 1), there is disclosed a method with resistance to impersonation to a server by an attacker, in authenticating a broadcast message from the server under the aforementioned condition.

According to the method described in the Patent Document 1, a node receives the data broadcasted by the server and the node resends a receipt acknowledgement of the broadcasted data to the server. After the server can confirm the resending of the receipt acknowledgement, the authentication key that has not disclosed to the network is disclosed to the node and the node confirms that the disclosed key is certainly the authentication key of the server to authenticate the received data as the correct data from the server.

According to the method described in the Nonpatent Literature 1, the server broadcasts the data and the node stores the broadcasted data in a buffer. The server discloses a key to the node in accordance with a predetermined time schedule and the node authenticates the disclosed key to authenticate the data stored in the buffer by using the key when the key is valid. When the data authentication fails, it can be detected that the data, which has been transmitted with an abnormally long delay, may be tampered with halfway.

In the conventional methods described in the Patent Document 1 and the Nonpatent Literature 1, however, the node cannot authenticate the received broadcast data until the authentication key is disclosed to the node. As a result, the node has to hold the received message until the disclosure of the authentication key. This problem leads to narrowing the available area of memory until the node authenticates the message and sometimes to a heavy load on the node having memory with only small capacity.

The present invention has been achieved in view of the aforementioned problems. An object of the present invention is to provide a novel and improved message authentication system and message authentication method capable of reducing the data capacity that the node (message receiving device) has to hold until the server (message sending device) discloses the authentication key.

### SUMMARY OF THE INVENTION

To solve the problems, according to an aspect of the present invention, there is provided a message authentication system having a message sending device that sends a message and a message receiving device that authenticates the sent message in a multihop network. The message sending device includes: an authentication code generation key managing unit that manages an authentication code generation key chain including two or more authentication code generation keys used for message authentication; a send notice information generating unit that generates send notice information configured by a first authentication code to certify the validity of the message and a second authentication code to certify the validity of the first authentication code, by using the authentication code generation key; and a sending unit that sends the send notice information to the message receiving device and that sends the message and the authentication code generation key after authenticating reception certification information sent from the message receiving device in accordance with the send notice information. The message receiving device includes: a reception certification information generating unit that generates the reception certification information to certify the receiving of the send notice information; a first authentication code authenticating unit that authenticates the first authentication code by using the second authentication code and the authentication code generation key sent from the message sending device; and a message authenticating unit that authenticates the message received from the message sending device by using the authenticated first authentication code and the authentication code generation key.

The authentication code generation key managing unit may generate each authentication code generation key by increasing sequentially the number of performing disclosed one-way function for an arbitrary value and may disclose each authentication code generation key to the message receiving device inversely with the order of being generated.

The send notice information generating unit may generate the first authentication code by using either the authentication code generation key that is not disclosed or a value generated by applying a predetermined one-way function disclosed to the authentication code generation key that is not disclosed.

The send notice information generating unit may generate the second authentication code by using either the authentication code generation key that is not disclosed or a value generated by applying a predetermined one-way function disclosed to the authentication code generation key that is not disclosed, and by using the first authentication code.

The message receiving device may verify whether the received authentication code generation key is disclosed or not and may authenticate the first authentication code by using the authentication code generation key when the authentication code generation key is not disclosed.

The message receiving device may further include a send notice information holding unit that holds the received send notice information in the order of reception until the authentication code generation key is sent from the message sending device. And the first authentication code authenticating unit may authenticate the first authentication code included in the send notice information held in the send notice information holding unit, may discard other send notice information held in the send notice information holding unit in the case of authenticating, and may discard the send notice information in the case of not authenticating.

The message sending device may send the message after dividing into two or more data blocks.

The send notice information generating unit may generate the send notice information corresponding to each of the data blocks. And the message authenticating unit may authenticate each of the data blocks by using the send notice information corresponding to each of the data blocks.

The send notice information generating unit may generate the send notice information corresponding to the message before divided. And the message authenticating unit may restore the message by combining all of the data blocks of the message and may authenticate the restored message by using the send notice information.

The message sending device may further include an authentication information adding unit that adds authentication information to each of the data blocks. And the authentication information adding unit may generate the authentication information by applying a predetermined and disclosed one-way function to an arbitrary data block, may add the generated authentication information to another data block, may apply the one-way function to the data block with the authentication information added and may repeat these operations to generate the authentication information.

The one-way function may be a hash function.

The send notice information generating unit may generate the send notice information corresponding to first authentication information as the authentication information finally generated. The sending unit may send the first authentication information and the authentication code generation key to the message receiving device before sending the data blocks and sends the data blocks after receiving a notification of the authentication of the first authentication information from the message receiving device. The message receiving device may further include an authentication information authenticating unit that authenticates the first authentication information by using the send notice information and the authentication code generation key.

The sending unit may send the data blocks inversely with the order of generating the authentication information, and the message authenticating unit may authenticate the data blocks by using the authentication information included in the data blocks received immediately before the data blocks.

To solve the problems, according to another aspect of the present invention, there is provided a message authentication method that authenticates a message sent from a message sending device by a multihop network in a message receiving device. The message authentication method includes: a message generating step of generating the message sent from the message sending device to the message receiving device; an authentication code generation key generating step of generating an authentication code generation key chain including two or more authentication code generation keys used for message authentication in the message sending device; a send notice information generating step of generating send notice information configured by a first authentication code to certify the validity of the message and a second authentication code to certify the validity of the first authentication code, by using the authentication code generation key in the message sending device; a send notice information sending step of sending the send notice information from the message sending device to the message receiving device; a reception certification information generating step of generating the reception certification information to certify the receiving of the send notice information in the message receiving device; a reception certification information authenticating step of authenticating, on the message sending device's side, the reception certification information sent from the message receiving device; an authentication code generation key sending step of sending the authentication code generation key from the message sending device to the message receiving device; a message sending step of sending the message from the message sending device to the message receiving device; a first authentication code authenticating step of authenticating, on the message receiving device's side, the first authentication code by using the second authentication code and the authentication code generation key sent from the message sending device; and a message authenticating step of authenticating the message that the message receiving device has received from the message sending device by using the authenticated first authentication code and the authentication code generation key.

The send notice information generating step may generate each authentication code generation key by increasing sequentially the number of performing disclosed one-way function for an arbitrary value disclosed, and each authentication code generation key included in the authentication code generation key chain may be disclosed to the message receiving device inversely with the order of being generated.

In the send notice information generating step, there may be generated the first authentication code by using either the authentication code generation key that is not disclosed or a value generated by applying a predetermined one-way function disclosed to the authentication code generation key that is not disclosed.

In the send notice information generating step, there may be generated the second authentication code by using either the authentication code generation key that is not disclosed or a value generated by applying a predetermined one-way function disclosed to the authentication code generation key that is not disclosed, and by using the first authentication code.

The message receiving device may verify whether the received authentication code generation key is disclosed or not before the first authentication code authenticating step and may authenticate the first authentication code by using the authentication code generation key when the authentication code generation key is not disclosed.

The message receiving device may hold the received send notice information in the order of reception until the authentication code generation key is sent from the message sending device, and there may be authenticated, in the first authentication code authenticating step, the first authentication code included in the held send notice information in the order of reception, may be discarded other send notice information in the case of authenticating, and may be discarded the send notice information in the case of not authenticating.

In the message generating step, the message may be generated by being dividing into two or more data blocks.

There may be generated, in the send notice information generating step, the send notice information corresponding to each of the data blocks, and there may be authenticated, in the message authenticating step, each of the data blocks by using the send notice information corresponding to each of the data blocks.

There may be generated, in the send notice information generating step, the send notice information corresponding to the message before divided, there may be further included the step of restoring the message by combining all of the data blocks of the message before the message authenticating step, and there may be authenticated, in the message authenticating step, the restored message by using the send notice information.

There may be further included an authentication information adding step of adding authentication information to each of the data blocks through the repetition of adding the authentication information generated by applying a predetermined and disclosed one-way function to an arbitrary data block before the send notice information generating step, to another data block, and applying the one-way function to the data block with the authentication information added.

The one-way function may be a hash function.

There may be generated, in the send notice information generating step, the send notice information corresponding to first authentication information as the authentication information finally generated. And, before the message sending step, there may be further included the step of sending the first authentication information and the authentication code generation key to the message receiving device and there may be further included an authentication information authenticating step of authenticating the first authentication information by using the send notice information and the authentication code generation key.

In the message sending step the data blocks may be sent inversely with the order of generating the authentication information, and in the message authenticating step the data blocks may be authenticated by using the authentication information included in the data blocks received immediately before the data blocks.

According to the present invention as described above, there can be reduced the data capacity that the node (message receiving device) has to hold until the server (message sending device) discloses the authentication key.

### BRIEF DESCRIPTION OF THE DRAWINGS

The above and other features of the invention and the concomitant advantages will be better understood and appreciated by persons skilled in the field to which the invention pertains in view of the following description given in conjunction with the accompanying drawings which illustrate preferred embodiments.

FIG. 1 is a block diagram showing a schematic configuration of a message authentication system according to a first embodiment of the present invention.

FIG. 2 is a block diagram showing a schematic configuration of a message sending device (server) according to the first embodiment.

FIG. 3 is a block diagram showing a schematic configuration of a message receiving device (node) according to the first embodiment.

FIG. 4 is an explanatory diagram to describe an authentication code generation key chain managed by an authentication code generation key managing unit.

FIG. 5 is a flowchart showing a flow of message authentication process according to the first embodiment.

FIG. 6 is a flowchart showing a flow of message authentication process according to the first embodiment.

FIG. 7 is an explanatory diagram showing a state in step S155 of the message authentication process according to the first embodiment.

FIG. 8 is an explanatory diagram showing the state in step S155 of the message authentication process according to the first embodiment.

FIG. 9 is an explanatory diagram showing a state in step S163 of the message authentication process according to the first embodiment.

FIG. 10 is an explanatory diagram showing a state of resending send information in the message authentication process according to the first embodiment.

FIG. 11 is a sequence diagram to describe an advantage of the message authentication system according to the first embodiment.

FIG. 12 is a block diagram showing a schematic configuration of a message sending device according to a second embodiment of the present invention.

FIG. 13 is a block diagram showing a schematic configuration of a message receiving device according to the second embodiment.

FIG. 14 is a flowchart showing a flow of message authentication process according to the second embodiment.

FIG. 15 is a flowchart showing a flow of message authentication process according to the second embodiment.

FIG. 16 is an explanatory diagram showing a state in step S254 of the message authentication process according to the second embodiment.

FIG. 17 is an explanatory diagram showing a state in step S256 of the message authentication process according to the second embodiment.

FIG. 18 is an explanatory diagram showing a state in step S262 of the message authentication process according to the second embodiment.

FIG. 19 is an explanatory diagram showing a state in step S270 of the message authentication process according to the second embodiment.

FIG. 20 is a block diagram showing a schematic configuration of a message sending device according to a third embodiment of the present invention.

FIG. 21 is a block diagram showing a schematic configuration of a message receiving device according to the third embodiment.

FIG. 22 is an explanatory diagram to describe authentication information added to a data block by an authentication information adding unit according to the third embodiment.

FIG. 23 is a flowchart showing a flow of message authentication process according to the third embodiment.

FIG. 24 is a flowchart showing a flow of message authentication process according to the third embodiment.

FIG. 25 is an explanatory diagram showing a state in step S356 of the message authentication process according to the third embodiment.

FIG. 26 is an explanatory diagram showing a state in step S358 of the message authentication process according to the third embodiment.

FIG. 27 is an explanatory diagram showing a state in step S364 of the message authentication process according to the third embodiment.

FIG. 28 is an explanatory diagram showing a state in step S372 of the message authentication process according to the third embodiment.

FIG. 29 is a sequence diagram showing a flow of process in a conventional message authentication system.

FIG. 30 is a sequence diagram showing an example of attack in the process in the conventional message authentication system.

### DETAILED DESCRIPTION OF THE PREFERRED EMBODIMENTS

Hereinafter, the preferred embodiment of the present invention will be described in reference to the accompanying drawings. Same reference numerals are attached to components having same functions in following description and the accompanying drawings, and a description thereof is omitted.

(Problem in the Conventional System)

In a conventional sensor network, a node has to hold the received data until an authentication key is disclosed from a server, and a heavy load is put on the node having memory with only small capacity. To solve such a problem, there has been invented the system of sending in the first place send notice information of the message that the server desires the authentication thereof and then sending the authentication key and the message after performing receipt acknowledgement of the send notice information.

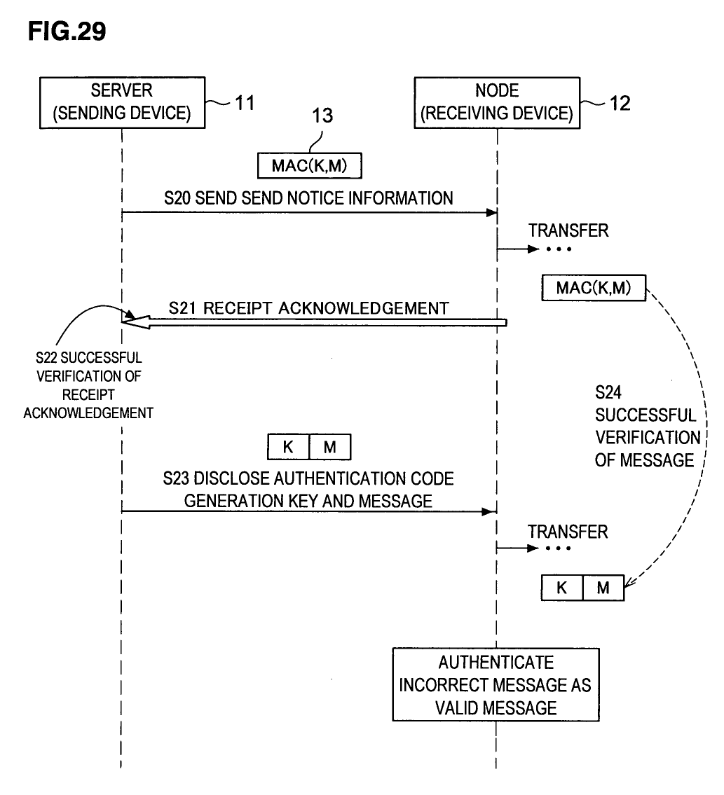

FIG. 29 is a sequence diagram showing a flow of process in the conventional message authentication system. There will be described a process in the case of sending a message M from a server 11 (message sending device) 11 to a node (message receiving device) 12 in reference to FIG. 29. First, the server 11 sends the send notice information to the node 12 (step S20). Here, send notice information 13 is a message authentication code (MAC; Message Authentication Codes) generated by using an authentication code generation key K for the message M, and indicated as MAC (K, M). The node 12 receives the send notice information MAC (K, M) to send a receipt acknowledgement to the server 11 (step S21). The server 11 verifies the receipt acknowledgement and in the case of successful verification (step S22) the message M and the authentication code generation key K are sent to the node 12 (step S23). When the node 12 verifies the received authentication code generation key K and authenticates that the authentication code generation key K is the valid key sent from the server 11, the message M is authenticated by using the authentication code generation key K and the send notice information MAC (K, M) (step S24). With such a method, the node only has to hold the sent notice information until the authentication code generation key is disclosed and it is not necessary to hold the message itself. Accordingly, the data capacity that the node has to hold can be reduced.

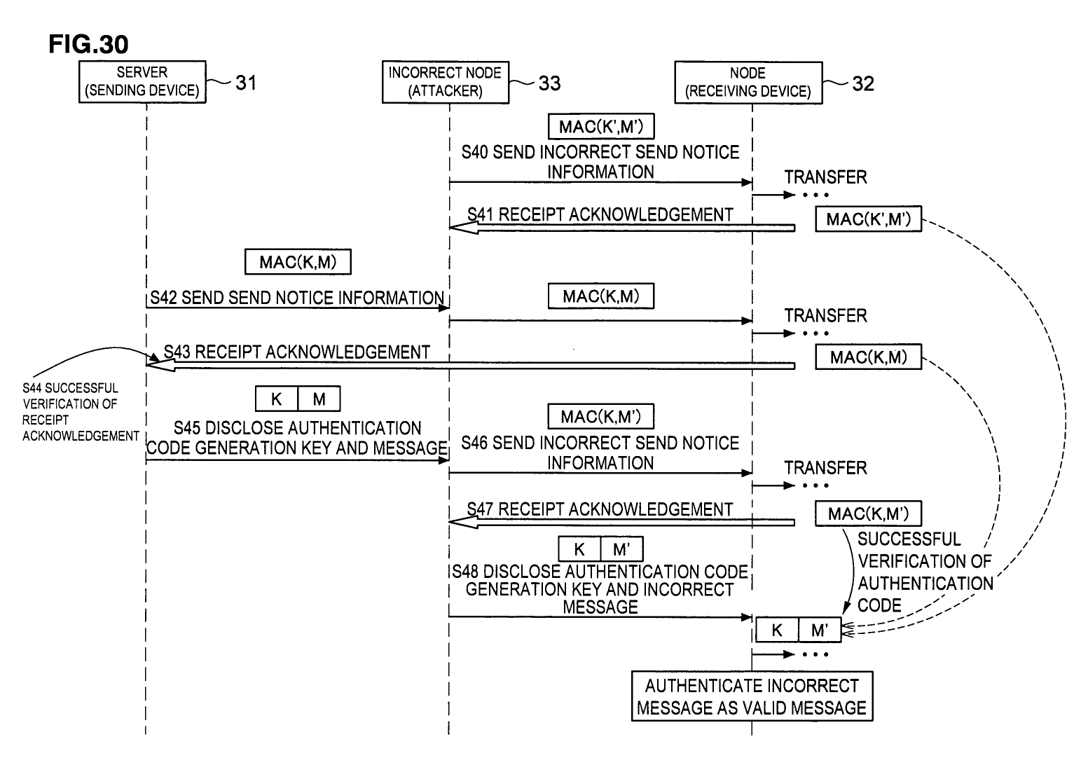

In such a conventional method, however, when the node allows the reception of the send notice information on a plurality of messages, an incorrect message sent from an incorrect relay node may be authenticated mistakenly. FIG. 30 is a sequence diagram showing an example of attack in the process in the conventional message authentication system. There will be described the case where an incorrect relay node 33 (hereafter, referred to as incorrect node 33) tries to send an incorrect message M′ to a node 32 in reference to FIG. 30.

First, the incorrect node 33 sends send notice information MAC (K′, M′) generated by using an incorrect authentication code generation key K′ to the node 32 (step S40) and the node 32 sends the receipt acknowledgement (step S41). Next, a server 31 sends the send notice information MAC (K, M) of the valid message to the node 32 via the incorrect node 33 (step S42). The node 32 sends the receipt acknowledgement to the server 31 (step S43). The server 31 verifies the receipt acknowledgement (step S44) to send the valid authentication code generation key K and the message M (step S45). The incorrect node 33 generates send notice information MAC (K, M′) of the incorrect message M′ by using the valid authentication code generation key K during the relay of the authentication code generation key K and the message M and sends to the node 32 (step S46). Then when the receipt acknowledgement is sent from the node 32 (step S47), the valid authentication code generation key K and the incorrect message M′ are sent to the node 32 (step S48).

In such a case, since the node 32 does not understand which send notice information that has already been received to use to verify the message, the node 32 may authenticate the incorrect message M′ as a valid message according to the send notice information MAC (K, M′) sent from the incorrect node 33.

Therefore in the present invention, the send notice information of the message that the message sending device (server) desires the authentication thereof and the authentication code to certify the validity of the send notice information of the message are sent first and then authentication code generation key and the message are sent. Thereby even when the message receiving device (node) allows the reception of the send notice information on a plurality of messages, the send notice information on an incorrect message can be blocked.

### First Embodiment

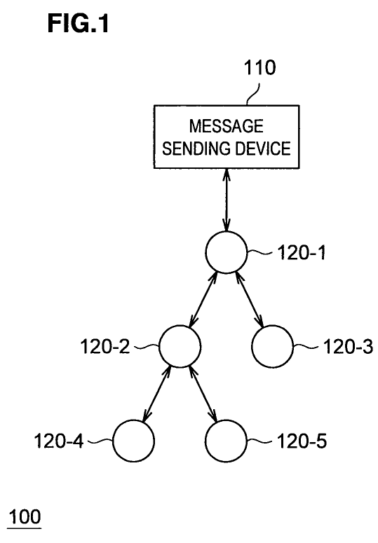

First, there will be described a message authentication system according to the first embodiment of the present invention in reference to FIG. 1. FIG. 1 is a block diagram showing a schematic configuration of a message authentication system 100 according to this embodiment. The message authentication system according to this embodiment, as shown in FIG. 1, is configured by a message sending device (server) 110 and a plurality of message receiving devices (nodes) 120-1 to 120-5 (hereafter, named generically as message receiving device 120). The message receiving device 120 is a device having, for example, a small wireless communication device built-in and each message receiving device 120 sends/receives data to/from the message sending device 110 wirelessly. The communication between the message sending device 110 and each message receiving device 120 is achieved by multihop communication. For example, when the message sending device 110 sends data to the message receiving device 120-4, the data is sent to the message receiving device 120-4 via the message sending devices 120-1 and 120-2 in sequence.

In the message authentication system 100 according to this embodiment, the message sending device 110 sends a first authentication code generated with regard to the message and a second authentication code to certify the validity of the first authentication code to the message receiving device 120. Then after the message sending device 110 confirms the arrivals of these two authentication codes at the message receiving device 120, the message sending device 110 sends an authentication code generation key and the message.

(Message Sending Device 110)

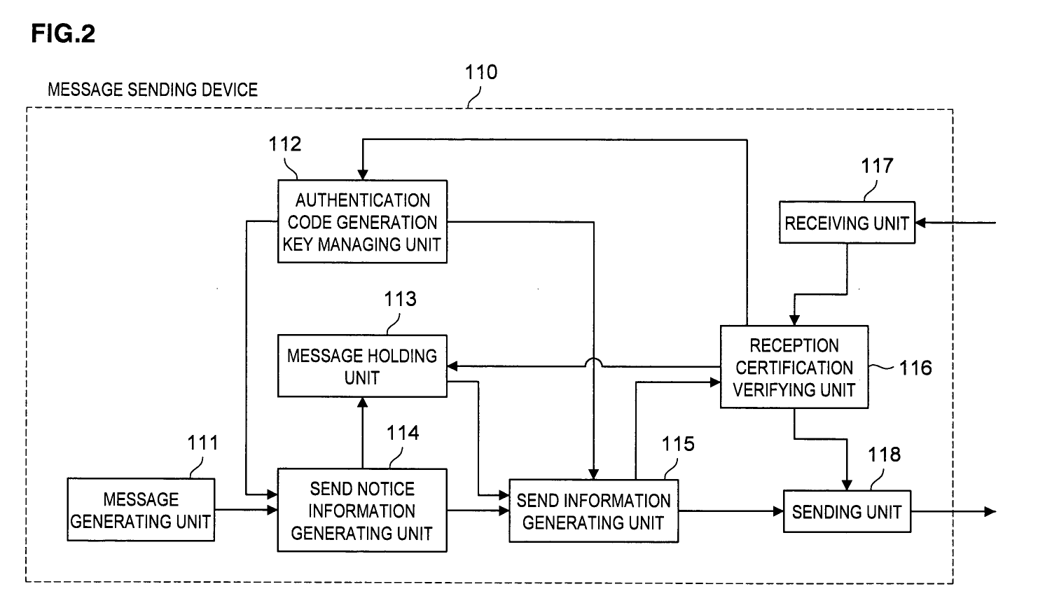

There will be described the message sending device (server) 110 in the message authentication system 100 according to this embodiment in reference to FIG. 2. FIG. 2 is a block diagram showing a schematic configuration of the message sending device (server) 110 according to this embodiment. The message sending device 110, as shown in FIG. 2, is configured by: a message generating unit 111; an authentication code generation key managing unit 112; a message holding unit 113; a send notice information generating unit 114; a send information generating unit 115; a reception certification verifying unit 116; a receiving unit 117; and a sending unit 118. Hereafter, each unit of the message sending device 110 will be described.

(Message Generating Unit 111)

The message generating unit 111 is an operation part to generate a message to be sent from the message sending device (server) 110 to the message receiving device (node) 120. The message generating unit 111 divides the generated message M into one or more data blocks Mⱼ (1≦j≦n, n≧1) and gives the divided data blocks Mⱼ to the send notice information generating unit 114.

(Authentication Code Generation Key Managing Unit 112)

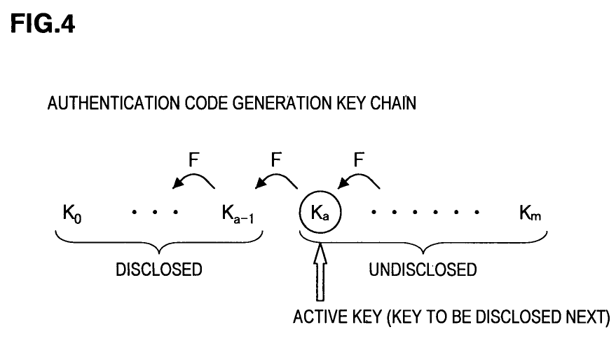

The authentication code generation key managing unit 112 is an operation part to manage an authentication code generation key chain Kᵢ (0≦i≦m, m≧1) used to generate the authentication code of message. FIG. 4 is an explanatory diagram to describe the authentication code generation key chain managed by the authentication code generation key managing unit 112. The authentication code generation key chain, as shown in FIG. 4, is configured by an arbitrary initial value Kₘ determined in the message sending device 110 and each of output values Kₘ₋₁, Kₘ₋₂, . . . , K₁, K₀ (Kᵢ=F(Kᵢ₊₁)) in the case of, for example, applying a predetermined one-way function F( ) to Kₘ more than once. Here, the one-way function F( ) is the function disclosed in both the message sending device 110 and the message receiving device 120. The message sending device 110 and the message receiving device 120 are assumed to share an authentication code generation key K₀ securely in an initial state. Each authentication code generation key in the generated authentication code generation key chain is used inversely (K₀→K₁→ . . . ) with the order of being generated.

As shown in FIG. 4, there is a distinction among each authentication code generation key included in the authentication code generation key chain with regard to whether the authentication code generation key has been disclosed to the network or not. In the authentication code generation keys that have not been disclosed, the authentication code generation key to be disclosed next is set as an active key Kₐ (0≦a≦m, m≧1). Since each authentication code generation key in the authentication code generation key chain is used and disclosed in the order of K₀→K₁→ . . . as described above, K₀, K₁, . . . , Kₐ₋₁ have been disclosed to the network and Kₐ, . . . , Kₘ₋₁, Kₘ have not been disclosed to the network.

The authentication code generation key managing unit 112 gives the present active key Kₐ to the send notice information generating unit 114 in response to the request from the send notice information generating unit 114. When the end of verifying reception certification information is notified of after a message indicating the end of reception certification verification is sent from the reception certification verifying unit 116, the present active key Kₐ is given to the send information generating unit 115 and disclosed to the network. Thereby since the present active key Kₐ is to be in the state of being disclosed, the authentication code generation key managing unit 112 sets a=a+1 and updates the present active key Kₐ to the authentication code generation key Kₐ₊₁ to be disclosed next.

The authentication code generation key managing unit 112 may hold the whole of generated authentication code generation key chain, or hold only the initial value Kₘ and generate each authentication code generation key by applying the one-way function F at the predetermined number of times in response to each request.

(Message Holding Unit 113)

The message holding unit 113 is a memory unit to hold the data block Mⱼ of the message to be sent to the message receiving device 120. The message holding unit 113 holds the data block Mⱼ given by the send notice information generating unit 114, and gives the held data block Mⱼ to the send information generating unit 115 when the end of verifying reception certification information is notified of after a message indicating the end of reception certification verification is sent from the reception certification verifying unit 116.

(Send Notice Information Generating Unit 114)

The send notice information generating unit 114 is an operation part to generate send notice information configured by the first authentication code and the second authentication code for arbitrary data. The send notice information generating unit 114 generates the first authentication code by using the authentication code generation key given by the authentication code generation key managing unit 112 or using derived information generated by being derived from the authentication code generation key with regard to the data block Mⱼ generated by the message generating unit 111. Further, the second authentication code generation key is generated by using the authentication code generation key given by the authentication code generation key managing unit 112 or the derived information thereof, with regard to the generated first authentication code. The first authentication code is the information to certify the validity of the data block Mⱼ while the second authentication code is the information to certify the validity of the first authentication code.

An authentication code generating algorithm used to generate the first authentication code and the second authentication code, which is not restricted, may be HMAC (HMAC; Keyed-Hashing for Message Authentication Code), CBC-MAC (CBC-MAC; Cipher Block Chaining-Message Authentication Code) or the like.

In this embodiment, when the authentication code generation key Kₐ is given by the authentication code generation key managing unit 112, the authentication code generation key used to generate the first authentication code is defined as Kₐ′=G(Kₐ) and the authentication code generation key used to generate the second authentication code is defined as Kₐ. However, this embodiment is not restricted to this example and an authentication code generation key other than those mentioned above may be used. Although the authentication code generation keys used to generate the first authentication code and the second authentication code are different, this embodiment is not restricted to this example and the same authentication code generation key may be used. Here, Go indicates an one-way function and is assumed to be the function disclosed to the message sending device 110 and the message receiving device 120.

The send notice information generating unit 114 gives the generated first and second authentication codes as the send notice information to the send information generating unit 115. In addition, the send notice information generating unit 114 gives the data block Mⱼ given by the message generating unit to the message holding unit 113.

(Send Information Generating Unit 115)

The send information generating unit 115 is an operation part to collect the data to be sent from each unit to the message receiving device 120 and to generate the send information to send the collected data. The send information generating unit 115 generates the send information including one or more pieces of information among the send notice information (first and second authentication codes) from the send notice information generating unit 114, the data block Mⱼ₋₁ from the message holding unit and Kₐ₋₁ from the authentication code generation key managing unit 112. Then the send information generating unit 115 gives the generated send information to the reception certification verifying unit 116 and the sending unit 118.

(Reception Certification Verifying Unit 116)

The reception certification verifying unit 116 is an operation part to verify by using the reception certification information received from the message receiving device 120 whether the send information that has been sent is received by the message receiving device 120 to be a target. The reception certification verifying unit 116 confirms whether the send information arrives at all message receiving devices 120 to be targets surely or whether the send information is not mistakenly sent to the specific message receiving device among the message receiving devices to be the targets, by verifying the reception certification information from the receiving unit 117. After the completion of certification, the reception certification verifying unit 116 sends a message indicating the end of reception certification verification to the authentication code generation key managing unit 112 and the message holding unit 113, to notify of the end of verification of the reception certification information.

When it is certified that the send information is not surely sent to the specific message receiving device, the message receiving device may break down, be stolen or attacked. Accordingly, the message receiving device may pull out of the network. Or, by giving the send information from the send information generating unit 115 to the sending unit 118, the send information may be resent to the corresponding message receiving device.

As the method of verifying whether the send information is received or not, the following method may be applied. The reception certification verifying unit 116 and the message receiving device 120 as the destination of the message share a pair of shared keys. The message receiving device 120 generates the authentication code (reception certification information) generated by using the above-mentioned shared keys in response to the send information received from the message sending device 110 to send the generated authentication code (reception certification information) to the message sending device 110. The message sending device 110 can obtain the receipt acknowledgement by verifying the authentication code (reception certification information) received by the message receiving device 120 by using the shared keys, in the reception certification verifying unit 116. It should be noted that the method of verifying reception certification information is not restricted to the above-described example and other method may be applied.

(Receiving Unit 117)

The receiving unit 117 is an operation part to receive the data sent from the message receiving device 120. The receiving unit 117 receives the reception certification information from the message receiving device 120 and gives the reception certification information to the reception certification verifying unit 116.

(Sending Unit 118)

The sending unit 118 is an operation part to send the data to the message receiving device 120. The sending unit 118 sends the send information from the send information generating unit 115 to the message receiving device 120 to be the destination of sending. The send information specified by the reception certification verifying unit 116 is resent to the message receiving device 120 specified by the reception certification verifying unit 116 as well.

Each unit of the message sending device 110 according to this embodiment has been described. It should be noted that the message generating unit 111, the authentication code generation key managing unit 112, the send notice information generating unit 114, the send information generating unit 115, the reception certification verifying unit 116, the receiving unit 117, and the sending unit 118 may be configured by the software where the program module capable of performing each function described above is installed in an information processor such as computer, or by the hardware such as processor capable of performing each function described above. The message holding unit 113 may be configured by, for example, various storage media such as semiconductor memory, optical disk, and magnetic disk.

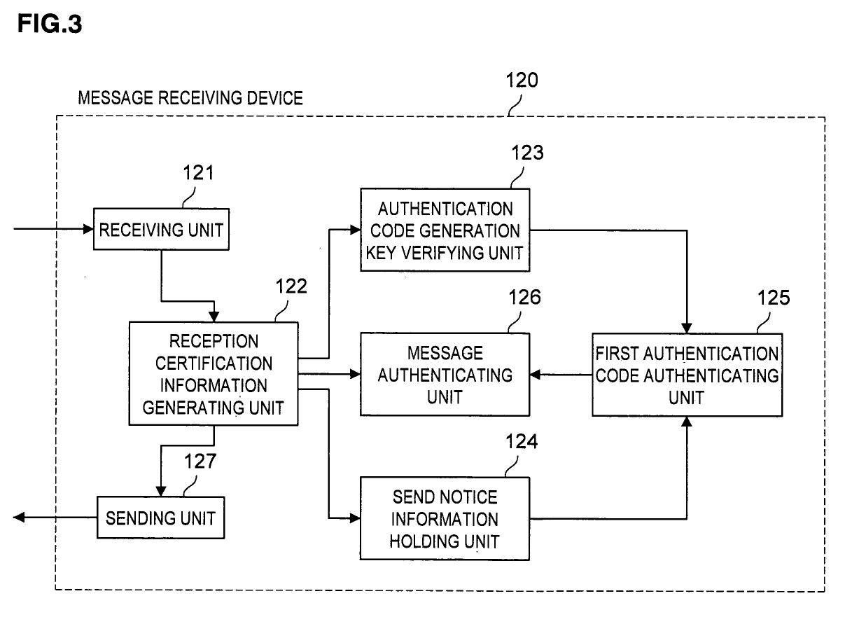

Next, there will be described the message receiving device (node) 120 in the message authentication system 100 according to this embodiment in reference to FIG. 3. FIG. 3 is a block diagram showing a schematic configuration of the message receiving device (node) 120 according to this embodiment. As shown in FIG. 3, the message receiving device 120 according to this embodiment is configured by: a receiving unit 121; a reception certification information generating unit 122; an authentication code generation key verifying unit 123; a send notice information holding unit 124; a first authentication code authenticating unit 125; a message authenticating unit 126; and a sending unit 127. Hereafter, each unit of the message receiving device 120 will be described.

(Receiving Unit 121)

The receiving unit 121 is an operation part to receive the send information sent from the message sending device 110. The receiving unit 121 receives each piece of send information from the message sending device 110 and gives to the reception certification information generating unit 122.

(Reception Certification Information Generating Unit 122)

The reception certification information generating unit 122 is an operation part to generate the reception certification information to certify that the send information from the receiving unit 121 is certainly received, for the message sending device 110.

As the method of certifying for the message sending device 110 that the send information is certainly received, the following method may be applied. The reception certification information generating unit 122 and the message sending device 110 share a pair of shared keys. The reception certification information generating unit 122 generates the authentication code (reception certification information) generated by using the above-mentioned shared keys in response to the send information received from the receiving unit 121 to send the generated authentication code (reception certification information) to the message sending device 110 via the sending unit 127. The message sending device 110 can obtain the receipt acknowledgement by verifying the authentication code (reception certification information) sent from the message receiving device 120 by using the shared keys, in, for example, the reception certification verifying unit 116. It should be noted that the method of reception certification is not restricted to the above-described example and other method may be applied. However, it is necessary to use the common method defined between the message sending device 110 and the message receiving device 120.

The reception certification information generating unit 122 gives the generated reception certification information to the sending unit 127. In addition, the reception certification information generating unit 122 gives the send notice information including the first authentication code and the second authentication code sent from the receiving unit 121. Also, the reception certification information generating unit 122 gives the data block Mⱼ from the receiving unit 121 to the message authenticating unit 126 and the authentication code generation key Kₐ to the authentication code generation key verifying unit.

(Authentication Code Generation Key Verifying Unit 123)

The authentication code generation key verifying unit 123 is an operation part to verify whether the authentication code generation key Kₐ received from the message sending device 110 is valid or not. The authentication code generation key verifying unit 123 is assumed to hold an authentication code generation key K₀ securely shared in an initial state by the message sending device 110 and the message receiving device 120. In addition, the authentication code generation keys K₁, . . . Kₐ₋₁ whose verification has succeeded may be held. The authentication code generation key verifying unit 123 can verify whether the authentication code generation key Kₐ is valid or not by judging whether the result of applying the one-way function F( ) defined in the system to the authentication code generation key Kₐ from the reception certification information generating unit 122 matches the held authentication code generation key Kₐ or not. The authentication code generation key verifying unit 123 holds newly the authentication code generation key Kₐ whose verification has succeeded as the authentication code generation key disclosed to the network the most recently and sends the authentication code generation key Kₐ to the first authentication code authenticating unit 125.

(Send Notice Information Holding Unit 124)

The send notice information holding unit 124 is a memory unit to hold the send notice information (first and second authentication codes) received from the message sending device 110. The send notice information holding unit 124 holds the send notice information from the reception certification information generating unit 122, storing the order of reception. In addition, the send notice information holding unit 124 gives the held send notice information to the first authentication code authenticating unit 125 in the order of reception in response to the request from the first authentication code authenticating unit 125.

(First Authentication Code Authenticating Unit 125)

The first authentication code authenticating unit 125 is an operation part to verify whether the first authentication code included in the send notice information from the message sending device 110 is valid or not. The first and second authentication codes for the data block Mⱼ are given to the first authentication code authenticating unit 125 from the send notice information holding unit 124 in the order of the reception. Further, the authentication code generation key Kₐ is given from the authentication code generation key verifying unit 123 and it is verified by using the Kₐ and the second authentication code whether the first authentication code is authenticated or not.

More specifically, the first authentication code authenticating unit 125 generates the authentication code for the first authentication code by using the authentication code generation key Kₐ and judges whether the generated authentication code matches the second authentication code or not to authenticate the first authentication code. The first authentication code authenticating unit 125 authenticates the first authentication code authenticated first as the valid first authentication code to certify the validity of the data block Mⱼ, in the send notice information held in the send notice information holding unit 124 and discards other send notice information. The first authentication code authenticating unit 125 gives the first authentication code normally authenticated and the authentication code generation key Kₐ to the message authenticating unit 126. Or, an output value K_{a′}, which is calculated by applying the one-way function G defined in the system to the authentication code generation key Kₐ, may be given to the message authenticating unit 126 instead of the authentication code generation key Kₐ.

(Message Authenticating Unit 126)

The message authenticating unit 126 is an operation part to authenticate whether the data block Mⱼ of the message received from the message sending device 110 is valid or not. The data block Mⱼ is given to the message authenticating unit 126 by the reception certification information generating unit 122 to authenticate the data block Mⱼ by using the authentication code generation key Kₐ or K_{a′} given from the first authentication code authenticating unit 125 and using the first authentication code. When the authentication code generation key Kₐ is given by the first authentication code authenticating unit 125, the one-way function G defined in the system is applied to the Kₐ to calculate the Kₐ′. For example, the following method may be applied as the method of authenticating the Mⱼ by the message authenticating unit 126. The authentication code for the data block Mⱼ is generated by using the Kₐ′ to judge whether the generated authentication code matches the first authentication code or not. In the case of matching, the data block Mⱼ is authenticated as a valid message. In the case of not matching, the data block Mⱼ is judged to be an invalid message and the message authenticating unit 126 may discard the data block Mⱼ.

(Sending Unit 127)

The sending unit 127 is an operation part to send information to the message sending device 110. The sending unit 127 sends the reception certification information given from the reception certification information generating unit 122 to the message sending device 110.

Each unit of the message receiving device 120 according to this embodiment has been described. It should be noted that the receiving unit 121, the reception certification information generating unit 122, the authentication code generation key verifying unit 123, the first authentication code authenticating unit 125, the message authenticating unit 126, and the sending unit 127 may be configured by the software where the program module capable of performing each function described above is installed in an information processor such as computer, or by the hardware such as processor capable of performing each function described above. The send notice information holding unit 124 may be configured by, for example, various storage media such as semiconductor memory, optical disk, and magnetic disk.

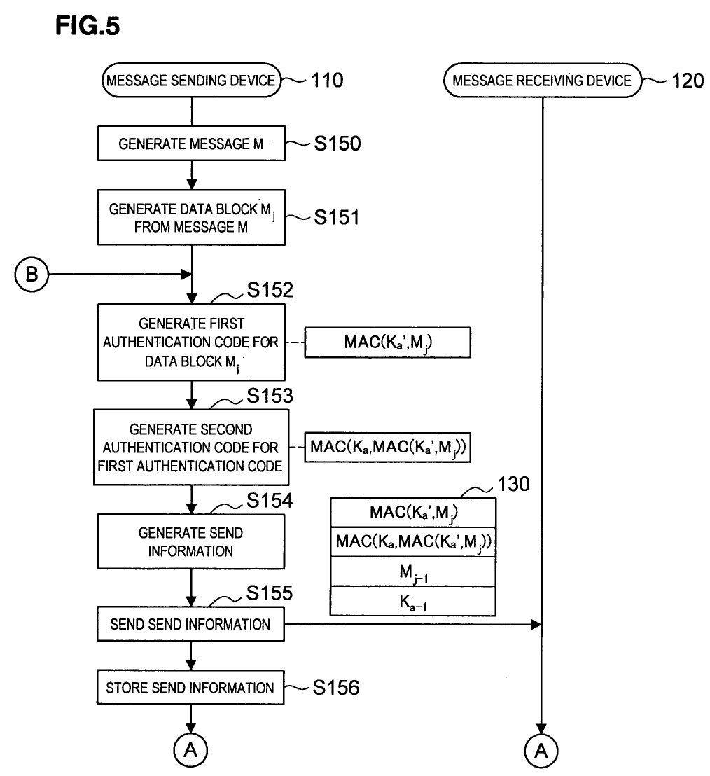

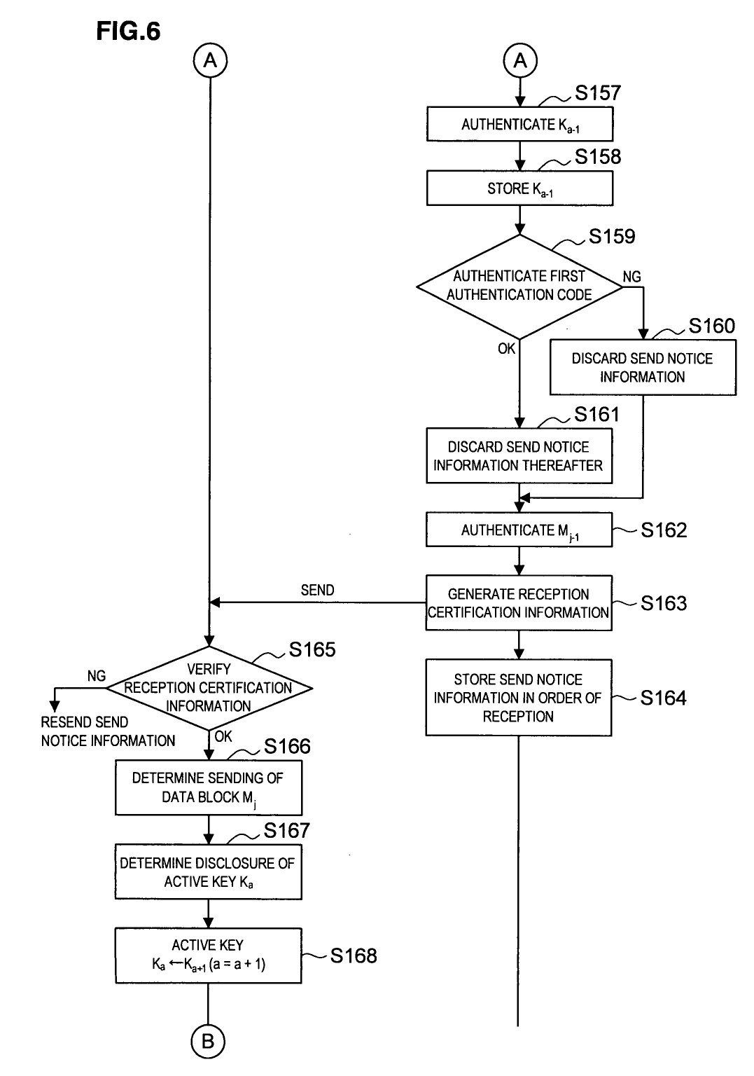

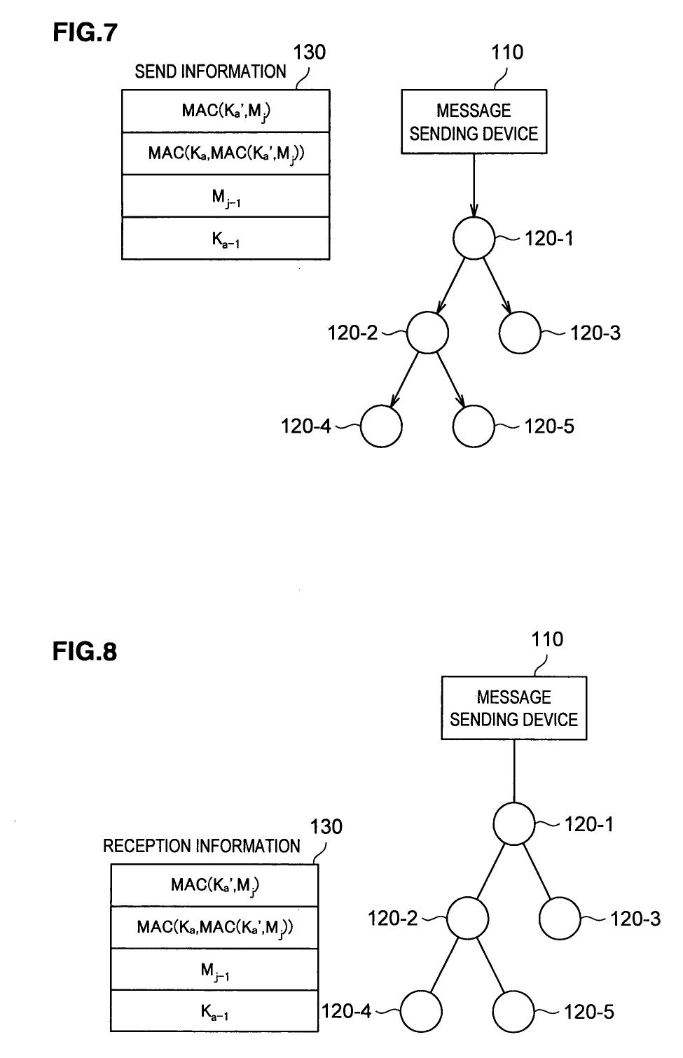

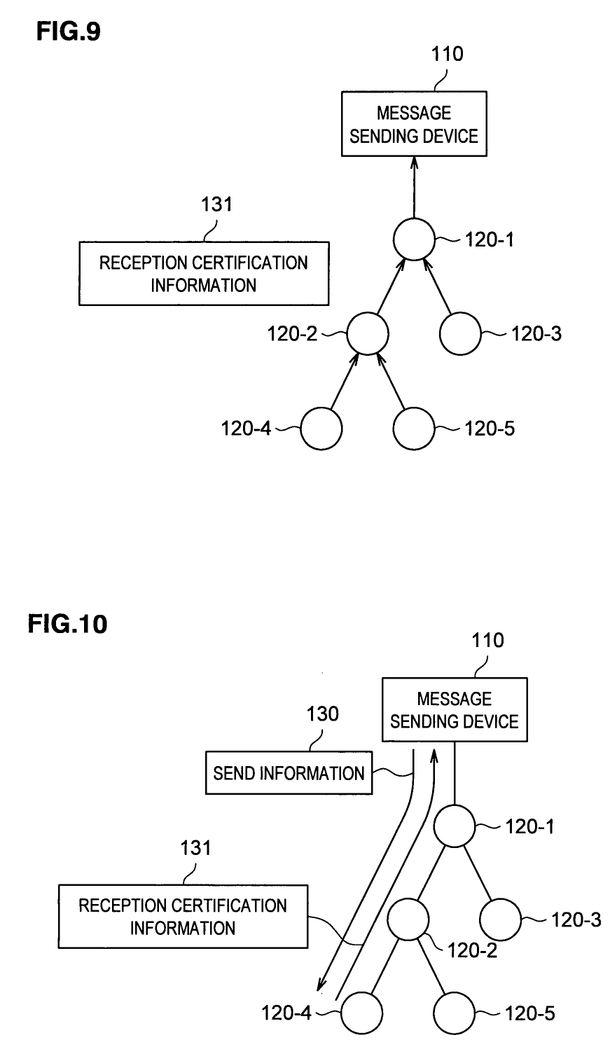

Next, there will be described an example of the message authentication process performed by the message authentication system 100 according to this embodiment in reference to FIGS. 5-10. Here, FIGS. 5 and 6 are flowcharts showing flows of message authentication process according to this embodiment. FIGS. 7 and 8 are explanatory diagrams showing states in step S155 of the message authentication process according to this embodiment. Similarly, FIG. 9 is an explanatory diagram showing a state in step S163 and FIG. 10 is an explanatory diagram showing a state of resending send information.

First in step S150, a message M to be sent is generated in the message generating unit 111 in the message sending device 110. Next in step S151, the message M is divided to generate j-data block Mⱼ (1≦j≦n, n≧1). The generated data block Mⱼ is given to the send notice information generating unit 114.

Next, the send notice information generating unit 114 generates the first and second authentication codes (send notice information). First in step S152, the first authentication code for the data block Mⱼ (information to certificate the validity of the Mⱼ) is generated. Here, a first authentication code MAC (Kₐ′, Mⱼ) is generated by using a value Kₐ′=G(Kₐ) calculated by applying the one-way function G to the present active key Kₐ that has not been disclosed to the network yet. The function G is assumed to be the function disclosed in the system.

Next in step S153, the second authentication code for the first authentication code MAC (Kₐ′, Mⱼ) (information to certificate the validity of the first authentication code) is generated. Here, a second authentication code MAC (Kₐ, MAC(Kₐ′, Mⱼ)) is generated by using the present active key Kₐ. The generated first and second authentication codes are given to the send information generating unit 115.

Next in step S154, the send information including the first authentication code MAC (Kₐ′, Mⱼ) and the second authentication code MAC (Kₐ, MAC(Kₐ′, Mⱼ)) is generated. The send notice information may include the data block Mⱼ₋₁ from the message holding unit 113 and the authentication code generation key Kₐ₋₁ from the authentication code generation key managing unit 112. Here, the data block Mⱼ₋₁ is the data block before the data block Mⱼ and the data block where the send notice information (first and second authentication codes) has already been sent to the message receiving device 120 and the reception of the send notice information in the message receiving device 120 is certified. In addition, the authentication code generation key Kₐ₋₁ is the authentication code generation key to be disclosed before the present active key Kₐ and used to generate the send notice information of the data block Mⱼ₋₁.

Next in step S155 as shown in FIG. 7, send information 130 generated is sent to the message receiving device 120 via the sending unit 118. The message receiving device 120 receives the sent send information 130 as shown in FIG. 8. Then the message sending device 110 stores the sent send information 130 in step S156.

In step S157, the message receiving device 120 authenticates the received authentication code generation key Kₐ₋₁ in the authentication code generation key verifying unit 123. For example, the authentication code generation key Kₐ₋₁ may be authenticated by judging whether the value generated by applying the one-way function F( ) defined in the system to the authentication code generation key Kₐ₋₁ matches the authentication code generation key Kₐ₋₂ authenticated before the authentication code generation key Kₐ₋₁ or not.

When the authentication code generation key Kₐ₋₁ is normally authenticated, the authentication code generation key Kₐ₋₁ is stored in step S158.

In step S159, the first authentication code included in the send notice information that has already been received in the message receiving device 120 and held in the send notice information holding unit 124 is authenticated. The send notice information holding unit 124 gives the held send notice information to the first authentication code authenticating unit 125 in the order of reception and the authentication is performed in the first authentication code authenticating unit 125. The send notice information for the data block Mⱼ₋₁ has already been stored in the send notice information holding unit 124. For example, the first authentication code authenticating unit 125 generates the authentication code for the first authentication code by using the authentication code generation key Kₐ₋₁ to judge whether the generated authentication code matches the second authentication code or not. Thereby the first authentication code is authenticated.

When the authentication is not normally performed, there proceeds to step S160 and the send notice information is discarded. When the authentication is normally performed, there proceeds to step S161 and the send notice information other than the authenticated send notice information is discarded.

Next in step S162, the data block Mⱼ₋₁ is authenticated in the message authenticating unit 126. The message authenticating unit 126 generates the authentication code for the Mⱼ₋₁ by using, for example, the value Kₐ₋₁′ calculated by applying the one-way function G defined in the system to the authentication code generation key Kₐ₋₁ authenticated in step S157 and authenticates the data block Mⱼ₋₁ by judging whether the generated value matches the first authentication code authenticated in step S159.

In step S163 as shown in FIG. 9, the reception certification information generating unit 122 generates reception certification information 131 for the send notice information received in step S155 to send to the message sending device 110 via the sending unit 127. Then in step S164, the send notice information is stored in the send notice information holding unit 124 in the order of reception.

In step S165, the message sending device 110 verifies the reception certification information 131 received from the message receiving device 120 in the reception certification verifying unit 116. When the reception is confirmed by the verification, there proceeds to step S166 to determine the sending of the data block Mⱼ. In step S167, it is determined that the authentication code generation key Kₐ used to generate the send notice information is disclosed to the network. In step S168, the active key Kₐ is updated to Kₐ₊₁.

As the result of verifying the reception certification information 131 in step S165, when the reception is not confirmed, the send information 130 may be resent to the message receiving device 120 as shown in FIG. 10.

An example of the message authentication process performed by the message authentication system 100 according to this embodiment has been described.

According to the configuration of this embodiment, the message sending device sends the first and second authentication codes generated for the data block of the message to the message receiving device to confirm that these two authentication codes reach the message receiving device and then sends the authentication code generation key and the data block. Thereby even when the message receiving device allows the reception of a plural pieces of send notice information (first and second authentication codes), incorrect send notice information can be blocked.

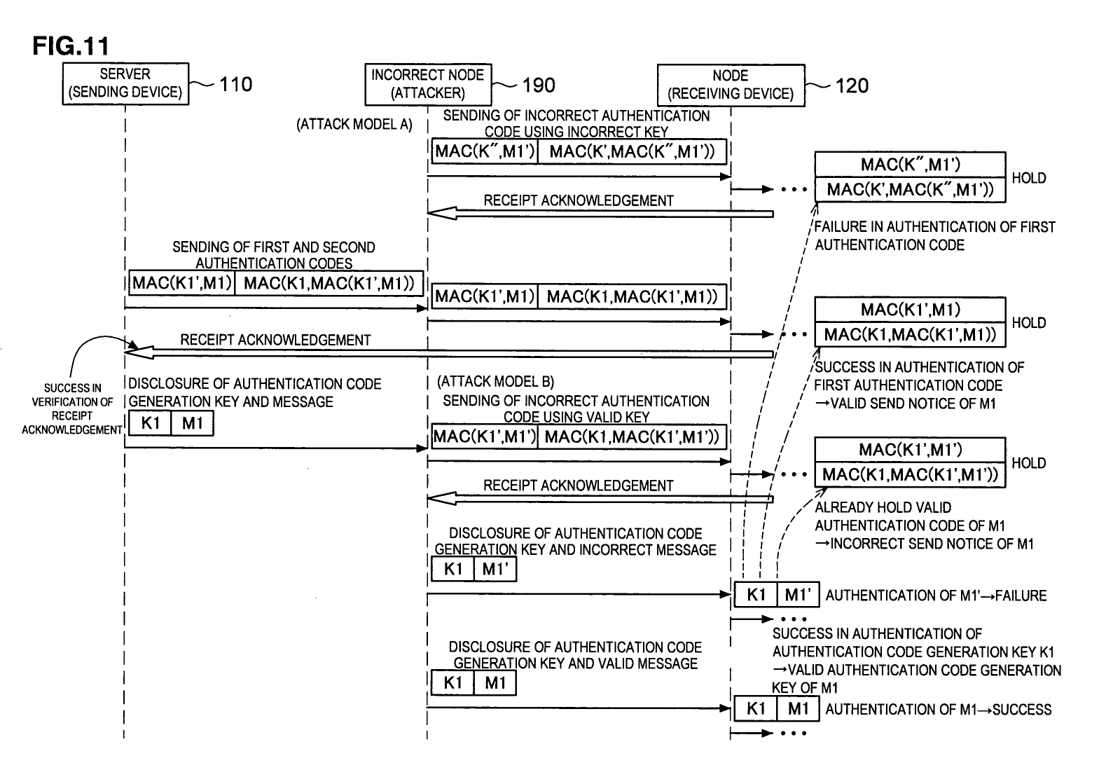

There will be described an advantage of the message authentication system 100 according to this embodiment. FIG. 11 is a sequence diagram to describe an advantage of the message authentication system 100 according to this embodiment.

In FIG. 11, MAC(X, Y) denotes the authentication code generated by using a key X for data Y; K1 denotes a valid authentication code generation key held by the server (message sending device) 110; K1′ denotes the value (K1′=G(K1)) with the one-way function G applied to K1; M1 denotes a valid message generated by the server; K′ and K″ denote keys having no significances generated by an incorrect node 190; and M1′ denotes an incorrect message generated by the incorrect node 190. The following two models will be assumed as the attack model in the case where the node (message receiving device) 120 allows the reception of send notice information on a plurality of messages.

(Attack Model A)

The incorrect node (attacker) 190 sends incorrect send notice information (first authentication code MAC(K″, M1) and second authentication code MAC(K′, MAC(K″, M1′))) created by using the incorrect key K″ for the incorrect message M1′ to the node 120 before the authentication code generation key K1 is disclosed. The node 120 sends the receipt acknowledgement (step S181) to hold the sent send notice information until the authentication code generation key K1 is disclosed.

(Attack Model B)

After the valid authentication code generation key K1 and the valid message M1 have been sent from the server 110, the incorrect node (attacker) 190 sends the send notice information (first authentication code MAC(K1′, M1′) and second authentication code MAC(K1, MAC(K1′, M1′))) for the incorrect data block M1′ to the node 120 by using the disclosed valid authentication code generation key K1.

In the case of the attack model A, the node (message receiving device) 120 cannot authenticate the first authentication code by using the disclosed valid key K1. In the case of the attack model A, therefore, the attacker cannot achieve the authentication of the incorrect message as the valid message.

In the case of the attack model B, the node (message receiving device) 120 authenticates the incorrect first authentication code by using the disclosed valid authentication code generation key K1. However, since the valid send notice information is authenticated before the incorrect first authentication code is authenticated, the valid send notice information is authenticated. If the valid send notice information is not authenticated, the authentication code generation key K1 is not in the state of being disclosed to the network. Accordingly, the attacker 190 cannot obtain the valid authentication code generation key K1 and consequently, the send notice information is to be discarded in the order of reception after the authentication of the valid send notice information. So the attacker 190 cannot achieve the authentication of the incorrect message as the valid message.

According to the message authentication information according to this embodiment as described above, even when the message receiving device allows the reception of send notice information on a plurality of messages, incorrect send notice information can be blocked. As a result, only the valid message can be authenticated.

### Second Embodiment

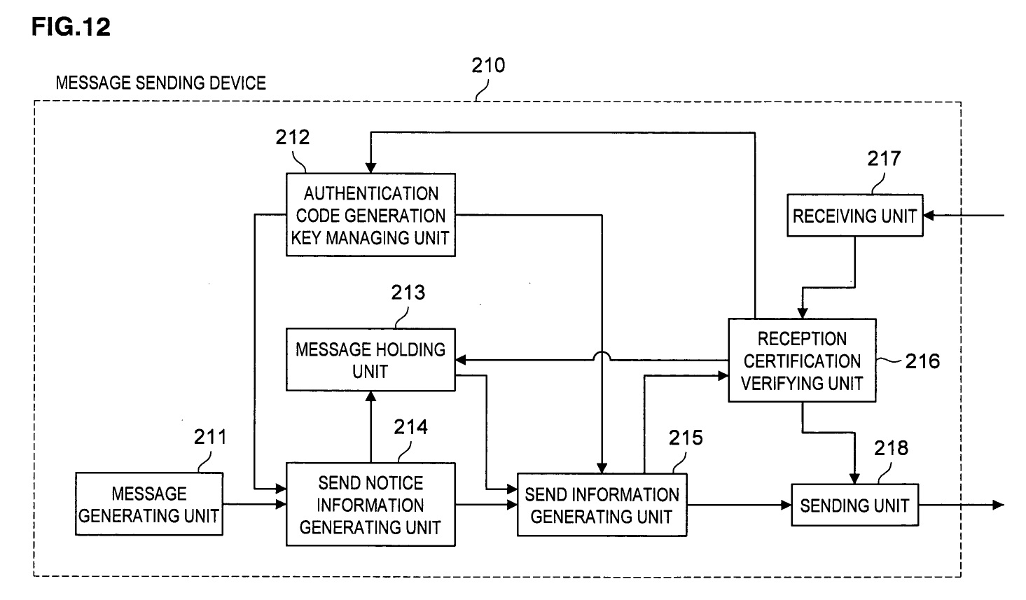

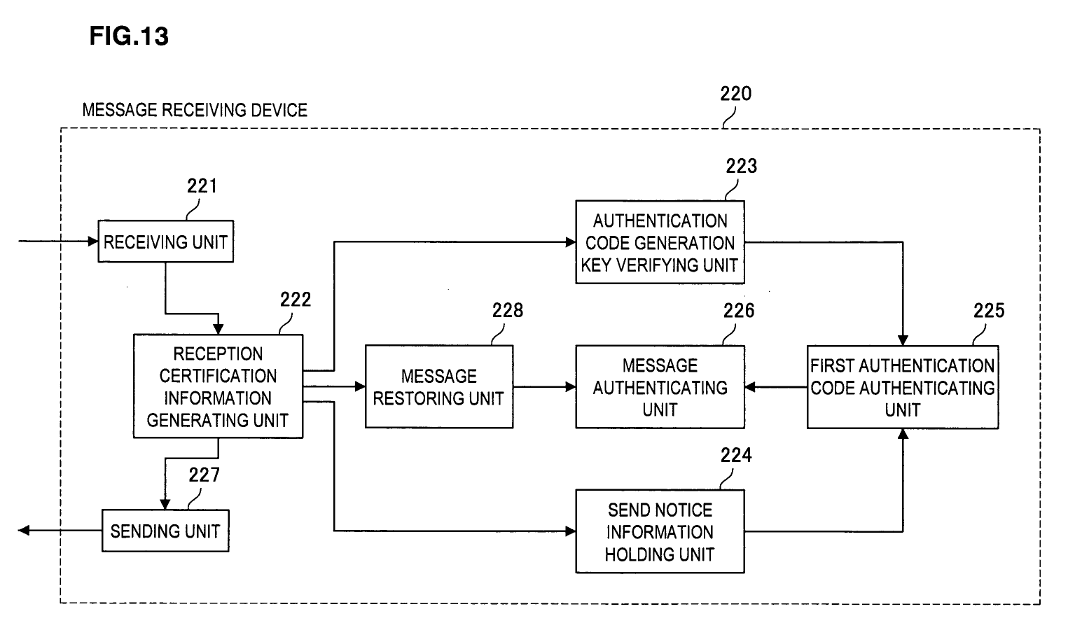

Next, there will be described a message authentication system according to the second embodiment of the present invention in reference to FIGS. 12 and 13. In the message authentication system according to this embodiment, a message sending device generates first and second authentication codes for the whole of message M before divided into a plurality of data blocks Mⱼ and confirms that the two authentication codes reach a message receiving device. After that, an authentication code generation key is generated and then data blocks M₁, M₂, . . . , Mₙ are sequentially sent.

(Message Sending Device 210)

There will be described the message sending device 210 in the message authentication system according to this embodiment in reference to FIG. 12. FIG. 12 is a block diagram showing a schematic configuration of the message sending device 210 according to this embodiment. The message sending device 210 according to this embodiment, which has substantially the same internal configuration as the message sending device 110 shown in FIG. 2 according to the first embodiment, is configured by: a message generating unit 211; an authentication code generation key managing unit 212; a message holding unit 213; a send notice information generating unit 214; a send information generating unit 215; a reception certification verifying unit 216; a receiving unit 217; and a sending unit 218. Hereafter, only the different component of message sending device 210 from that of the message sending device 110 according to the first embodiment will be described.

(Message Generating Unit 211)

The message generating unit 211 is an operation part to generate a message to be sent from the message sending device (server) 210 to the message receiving device (node) 220. The message generating unit 211 has substantially the same function as the message generating unit 111 according to the first embodiment as described above except that the message generating unit 211 gives the generated message M to the send notice information generating unit 214.

(Authentication Code Generation Key Managing Unit 212)

The authentication code generation key managing unit 212 is an operation part to manage an authentication code generation key chain Kᵢ (0≦i≦m, m≧1) used to generate the authentication code of message. The authentication code generation key managing unit 212 has substantially the same function as the authentication code generation key managing unit 112 according to the first embodiment described above.

(Message Holding Unit 213)

The message holding unit 213 is a memory unit to hold a message M to be sent to the message receiving device 220. The message holding unit 213 according to this embodiment has substantially the same function as the message holding unit 113 according to the first embodiment described above except that the information given by the send notice information generating unit 214 and the information to be given to the send information generating unit 215 are the message M.

(Send Notice Information Generating Unit 214)

The send notice information generating unit 214 is an operation part to generate send notice information configured by the first authentication code and the second authentication code for arbitrary data. The send notice information generating unit 214 has substantially the same function as the send notice information generating unit 114 according to the first embodiment described above except for the following points. The send notice information generating unit 214 according to this embodiment generates the first authentication code and the second authentication code for the message M from the message generating unit 211 and gives to the send information generating unit 215. In addition, the message M is given to the message holding unit 213.

(Send Information Generating Unit 215)

The send information generating unit 215 is an operation part to collect the data to be sent from each unit to the message receiving device 220 and to generate the send information to send the collected data. The send information generating unit 215 receives the first and second authentication codes for the message M from the send notice information generating unit 214 and generates the send information including the received first and second authentication codes to give the generated send information to the reception certification verifying unit 216 and the sending unit 218. When the message M is received from the message holding unit 213, the message M is divided into one or more data blocks Mⱼ (1≦j≦n, n≧1) and generates the send information including each data block Mⱼ and the generated send information is sequentially given to the reception certification verifying unit 216 and the sending unit 218. A sequence number j indicating the order of sending may be attached to the send information including each data block Mⱼ. When an authentication code generation key Kₐ is received from the authentication code generation key managing unit 212, the send information including the authentication code generation key Kₐ is generated and the generated send information is given to the reception certification verifying unit 216 and the sending unit 218.

(Reception Certification Verifying Unit 216)

The reception certification verifying unit 216 is an operation part to verify by using the reception certification information received from the message receiving device 220 whether the send information that has been sent is received by the message receiving device 220 to be a target. The reception certification verifying unit 216 according to this embodiment verifies the reception certification information received from the message receiving device 220 via the receiving unit 217 by using the send notice information (first and second authentication codes) received from the send information generating unit 215. When it is confirmed that the send notice information has been correctly received in the message receiving device 220, a message indicating the end of reception certification verification is sent to the authentication code generation key managing unit 212 and the message holding unit 213.

The reception certification verifying unit 216 receives the authentication code generation key Kₐ or the data block Mⱼ from the send information generating unit 215 to verify whether the information has been correctly received in the message receiving device 220 or not. More specifically, similarly to the case of the send notice information, the reception certification information is received from the message receiving device 220 and the reception certification information may be verified by using the authentication code generation key Kₐ or the data block Mⱼ. Or, it may be detected whether the send information has reached the message receiving device 220 or not with the sending of ACK/NACK from the message receiving device 220. When the send information does not reach, this may be resent by giving the authentication code generation key Kₐ or the data block Mⱼ to the sending unit 218. Here, the message indicating the end of reception certification verification is not sent when the reception is confirmed, which is different from the case of receipt acknowledgement of the send notice information described above.

(Receiving Unit 217, Sending Unit 218)

Since the receiving unit 217 and the sending unit 218 have substantially the same functions as the receiving unit 117 and the sending unit 118 according to the first embodiment, respectively, the descriptions thereof will be omitted.

Each unit of the message sending device 210 according to this embodiment has been described, focusing the differences from each of the corresponding units in the first embodiment. It should be noted that the message generating unit 211, the authentication code generation key managing unit 212, the send notice information generating unit 214, the send information generating unit 215, the reception certification verifying unit 216, the receiving unit 217, and the sending unit 218 may be configured by the software where the program module capable of performing each function described above is installed in an information processor such as computer, or by the hardware such as processor capable of performing each function described above. The message holding unit 213 may be configured by, for example, various storage media such as semiconductor memory, optical disk, and magnetic disk.

(Message Receiving Device 220)

Next, there will be described the message receiving device 220 in the message authentication system according to this embodiment in reference to FIG. 13. FIG. 13 is a block diagram showing a schematic configuration of the message receiving device 220 according to this embodiment. As shown in FIG. 13, the message receiving device 220 according to this embodiment is configured by: a receiving unit 221; a reception certification information generating unit 222; an authentication code generation key verifying unit 223; a send notice information holding unit 224; a first authentication code authenticating unit 225; a message authenticating unit 226; a sending unit 227; and a message restoring unit 228.

Each unit of the message receiving device 220 according to this embodiment has substantially the same configuration as each unit of the message receiving device 120 according to the first embodiment except for the reception certification information generating unit 222, the message authenticating unit 226 and the message restoring unit 228. Accordingly, the detailed description thereof will be omitted. Hereafter, there will be described the reception certification information generating unit 222, the message authenticating unit 226 and the message restoring unit 228 in the message receiving device 220 according to this embodiment.

(Reception Certification Information Generating Unit 222)

The reception certification information generating unit 222 is an operation part to generate the reception certification information to certify that the send information from the receiving unit 221 is certainly received, for the message sending device 210. The reception certification information generating unit 222 according to this embodiment has substantially the same function as the reception certification information generating unit 122 according to the first embodiment described above except for the following points.

When the send information received from the receiving unit 221 is the authentication code generation key Kₐ or the data block Mⱼ, the reception certification information generating unit 222 according to this embodiment may generate an ACK message or an NACK message to certify the certain reception of the information, for the message sending device 210, and may send the message via the sending unit 227.

The reception certification information generating unit 222 also gives the data block Mⱼ from the receiving unit 221 to the message restoring unit 228.

(Message Authenticating Unit 226)

The message authenticating unit 226 is an operation part to authenticate whether the message received from the message sending device 210 is valid or not. The message authenticating unit 226 according to this embodiment has substantially the same function as the message authenticating unit 126 according to the first embodiment described above except for the following points. A message M is given to the message authenticating unit 226 according to this embodiment by the message restoring unit 228 and the message authenticating unit 226 authenticates that the message M is a valid message sent from the message sending device 210 by using the authentication code generation key Kₐ or Kₐ′ given from the first authentication code authenticating unit 125 and using the first authentication code.

(Message Restoring Unit 228)

The message restoring unit 228 is an operation part to restore the original message M from the divided data block Mⱼ sent from the message sending device 210. The message restoring unit 228 receives the data block Mⱼ from the reception certification information generating unit 222 to restore the message M. The message restoring unit 228 also gives the restored message to the message authenticating unit 226.

Each unit of the message receiving device 220 according to this embodiment has been described. It should be noted that the receiving unit 221, the reception certification information generating unit 222, the authentication code generation key verifying unit 223, the first authentication code authenticating unit 225, the message authenticating unit 226, the sending unit 227 and the message restoring unit 228 may be configured by the software where the program module capable of performing each function described above is installed in an information processor such as computer, or by the hardware such as processor capable of performing each function described above. The send notice information holding unit 224 may be configured by, for example, various storage media such as semiconductor memory, optical disk, and magnetic disk.

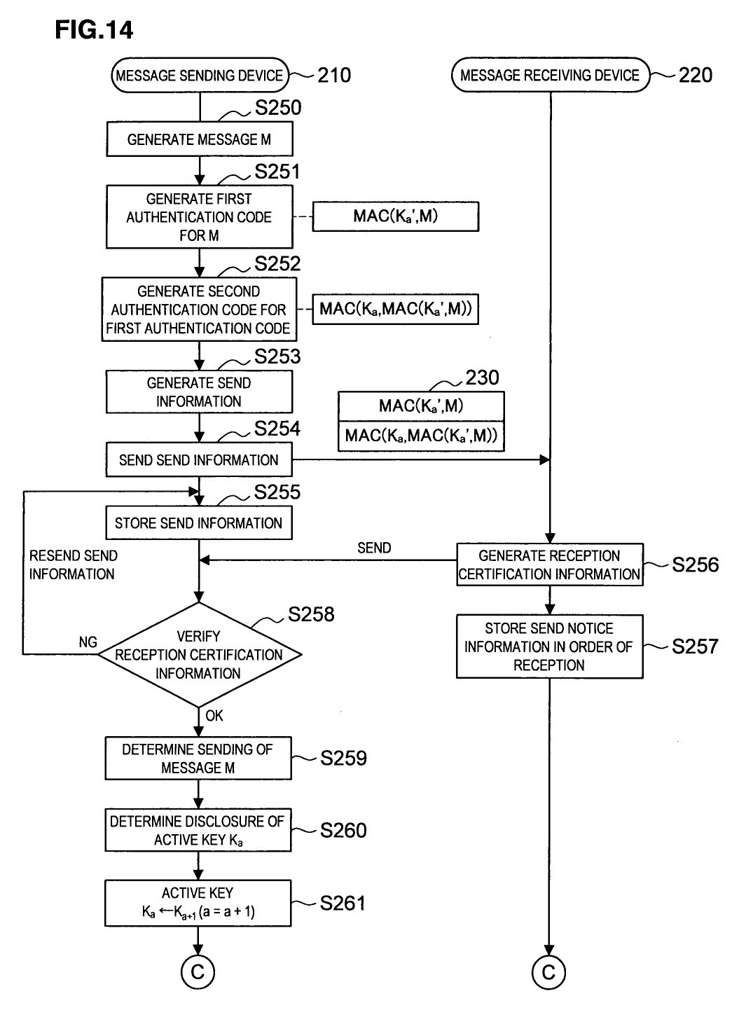

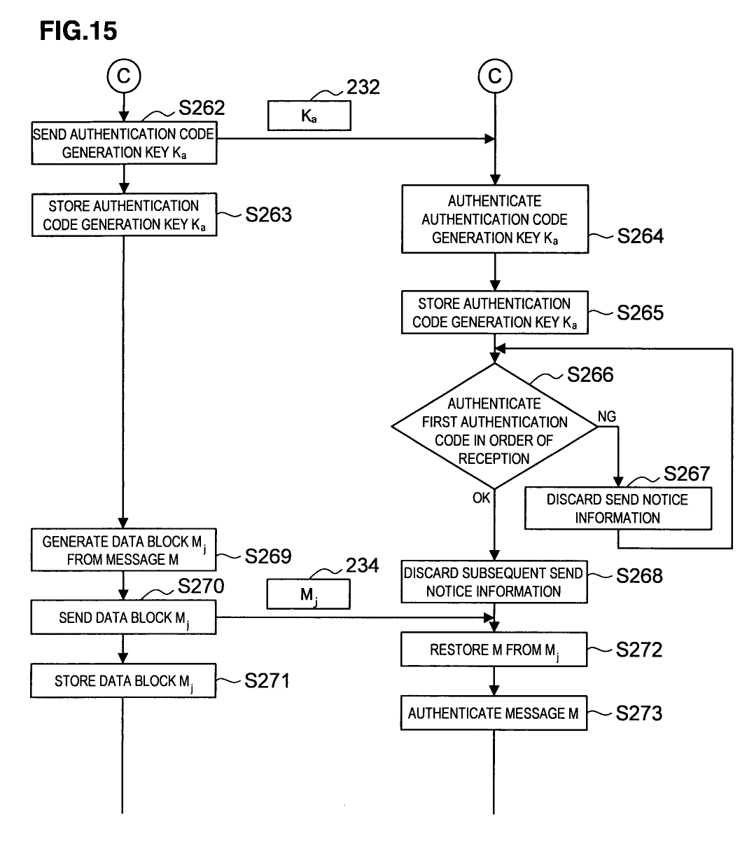

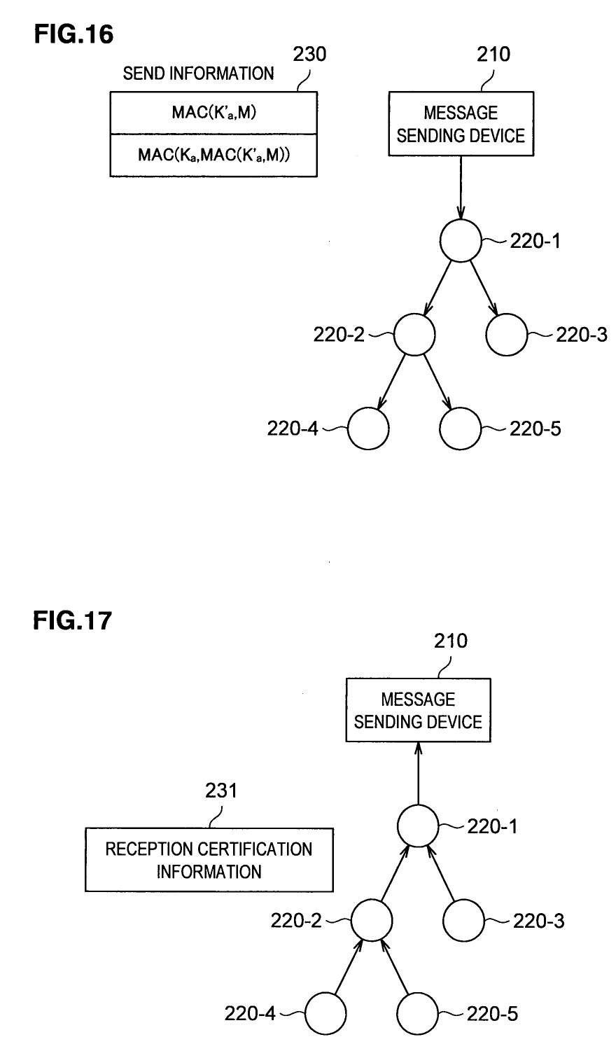

Next, there will be described an example of the message authentication process performed by the message authentication system according to this embodiment in reference to FIGS. 14-19. Here, FIGS. 14 and 15 are flowcharts showing flows of message authentication process according to this embodiment. FIG. 16 is an explanatory diagram showing a state in step S254 of the message authentication process according to this embodiment. Similarly, FIGS. 17, 18 and 19 are explanatory diagrams showing states in steps S256, S262 and S270.

First in step S250, the message M to be sent is generated in the message generating unit 211 in the message sending device 210. The generated message M is given to the send notice information generating unit 214.

Next, the send notice information generating unit 214 generates the first authentication code for the message M in step S251. Here, a first authentication code MAC (Kₐ′, M) is generated by using a value Kₐ′=G(Kₐ) calculated by applying the one-way function G to the present active key Kₐ that has not been disclosed to the network yet. The function G is assumed to be the function disclosed in the system.

Next in step S252, the second authentication code for the first authentication code MAC (Kₐ′, Mⱼ) (information to certificate the validity of the first authentication code) is generated. Here, a second authentication code MAC (Kₐ, MAC(Kₐ′, Mⱼ)) is generated by using the present active key Kₐ. The generated first and second authentication codes are given to the send information generating unit 215.

Next in step S253, the send information including the first authentication code MAC (Kₐ′, M) and the second authentication code MAC (Kₐ, MAC(Kₐ′, M)) is generated in the send information generating unit 215.

Next in step S254 as shown in FIG. 16, send information 230 generated is sent to the message receiving device 220 via the sending unit 218. After the sending, the message sending device 210 stores the sent send information 230 in step S255.

The message receiving device 220 gives the send information 230 received via the receiving unit 221 to the reception certification information generating unit 222. The reception certification information generating unit 222 generates reception certification information 231 for the send information 230 in step S256, and sends to the message sending device 210 as shown in FIG. 17. Next in step S257, the send notice information included in the send information 230 is given to the send notice information holding unit 224 and stored in the order of reception.

In step S258, the message sending device 210 having received the reception certification information 231 from the message receiving device 220 in step S256 verifies the reception certification information 231 in the reception certification verifying unit 216. When the reception is confirmed by the verification, there proceeds to step S259 to determine the sending of the message M. In step S260, it is determined that the authentication code generation key Kₐ used to generate the send notice information is disclosed to the network. In step S261, the active key Kₐ is updated to Kₐ₊₁.

As the result of verifying the reception certification information 231 in step S258, when the reception is not confirmed, the send information 230 may be resent to the message receiving device 220, getting back to step S255.

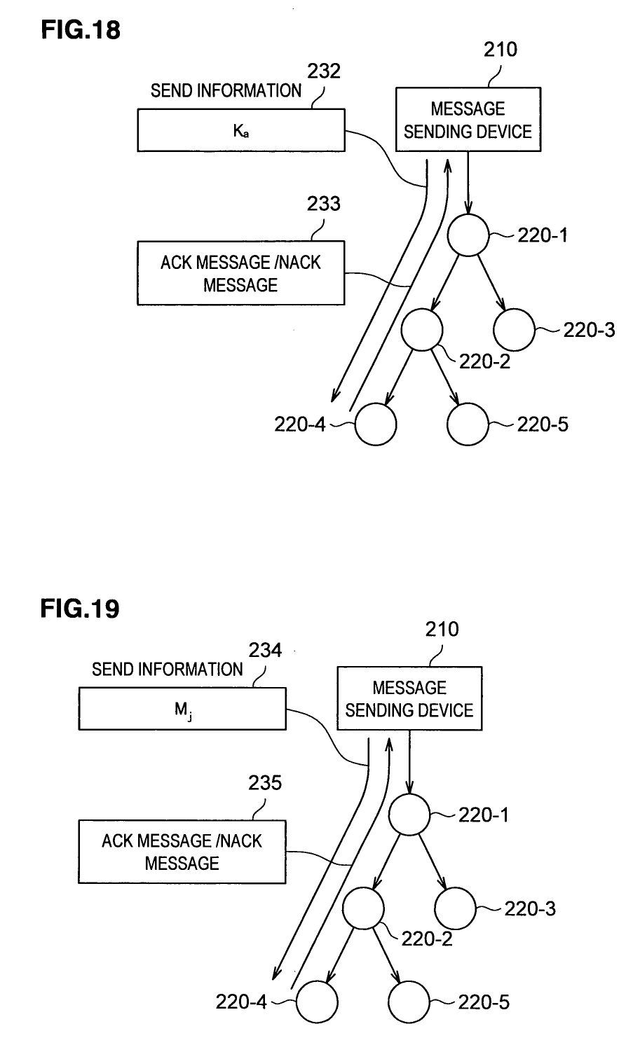

In step S262, as shown in FIG. 18, send information 232 including the authentication code generation key Kₐ is sent from the message sending device 210 to the message receiving device 220. The message receiving device 220 may confirm the reception of the send information 232 and, as shown in FIG. 18, send an ACK/NACK message 233 to the message sending device 210. After the sending, the message sending device 210 stores the authentication code generation key Kₐ in step S263.

The message receiving device 220 having received the authentication code generation key Kₐ authenticates the authentication code generation key Kₐ in step S264. When the authentication code generation key Kₐ is normally authenticated, the authentication code generation key Kₐ is stored in step S265.

In step S266, the first authentication code included in the send notice information held in the send notice information holding unit 224. The send notice information holding unit 224 gives the held send notice information to the first authentication code authenticating unit 225 in the order of reception and the authentication is performed in the first authentication code authenticating unit 225. For example, the first authentication code authenticating unit 225 generates the authentication code for the first authentication code by using the authentication code generation key Kₐ to judge whether the generated authentication code matches the second authentication code or not. Thereby the first authentication code is authenticated.

When the authentication is not normally performed, there proceeds to step S267 and the send notice information is discarded. When the authentication is normally performed, there proceeds to step S268 and the send notice information other than the authenticated send notice information is discarded.

In step S269, on the other hand, the message sending device 210 generates the data block Mⱼ from the message M. Next in step S270, as shown in FIG. 19, send information 234 including the generated data block Mⱼ is sequentially sent to the message receiving device 220. The message receiving device 220 may confirm the reception of the send information 234 and, as shown in FIG. 19, send an ACK/NACK message 235 to the message sending device 210. After the sending, the message sending device 210 stores the authentication code generation key Kₐ in step S271.

After all data blocks Mⱼ are sent from the message sending device 210 to the message receiving device 220, the message M is restored from the data block Mⱼ in the message restoring unit 228 in step S272.

In step S273, the message M is authenticated in the message authenticating unit 226. For example, the message authenticating unit 226 generates the authentication code for the message M by using a value Kₐ′ calculated by applying the one-way function G defined in the system to the authentication code generation key Kₐ authenticated in step S264, judges whether the generated value matches the first authentication code authenticated in step S266 and thereby authenticates the message M.

An example of the message authentication process performed by the message authentication system according to this embodiment has been described.

According to the configuration of this embodiment, the message sending device sends the first authentication code generated for the whole message M before divided into a plurality of data blocks Mⱼ (1≦j≦n, n≧1) and the second authentication code to certify the validity of the first authentication code to the message receiving device to confirm that these two authentication codes reach the message receiving device. And then the authentication code generation key is disclosed and the data blocks M₁, M₂, . . . , Mₙ are sequentially sent.

As described above, sending one authentication code to one message makes it possible to increase the size of data block of the message that can be included in one packet, compared to the first embodiment in which each packet including the first and second authentication codes and the authentication code generation key is sent.

### Third Embodiment

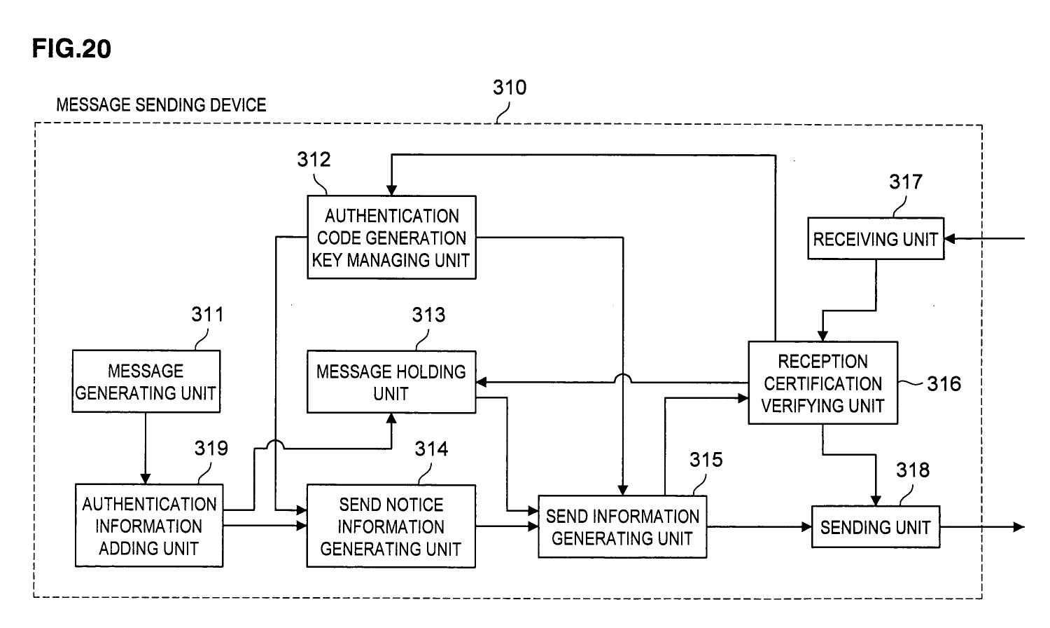

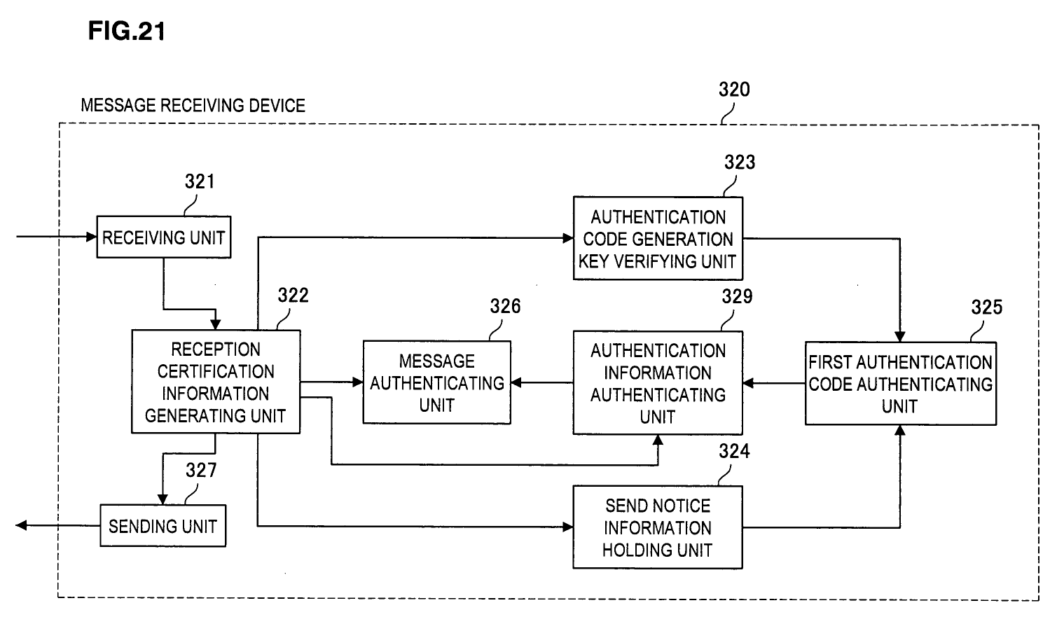

Next, there will be described a message authentication system according to the third embodiment of the present invention in reference to FIGS. 20 and 21. In the message authentication system according to this embodiment, a message sending device generates send notice information for the first packet while a message receiving device regards the authentication of the first packet as a commitment. Thereby the packet to be received subsequently is authenticated.

(Message Sending Device 310)

There will be described the message sending device 310 in the message authentication system according to this embodiment in reference to FIG. 20. FIG. 20 is a block diagram showing a schematic configuration of the message sending device 310 according to this embodiment. The message sending device 310 according to this embodiment is configured by: a message generating unit 311; an authentication code generation key managing unit 312; a message holding unit 313; a send notice information generating unit 314; a send information generating unit 315; a reception certification verifying unit 316; a receiving unit 317; a sending unit 318; and an authentication information adding unit 319, as shown in FIG. 20.

Each unit configuring the message sending device 310 according to this embodiment has substantially the same configuration as the component of the message sending device according to the first embodiment as described above. Hereafter, only the message generating unit 311, the message holding unit 313, the send notice information generating unit 314, the send information generating unit 315, the reception certification verifying unit 316, and the authentication information adding unit 319 which have different functions from the components of the message sending device 110 according to the first embodiment will be described, in the components of the message sending device 310 according to this embodiment.

(Message Generating Unit 311)

The message generating unit 311 is an operation part to generate a message to be sent from the message sending device (server) 310 to the message receiving device (node) 320. The message generating unit 311 has substantially the same function as the message generating unit 111 according to the first embodiment as described above except that the message generating unit 311 divides the generated message M into one or more data blocks Mⱼ (1≦j≦n, n≧1) and gives the divided data block Mⱼ to the authentication information adding unit 319.

(Message Holding Unit 313)

The message holding unit 313 is a memory unit to hold a data block of message M to be sent to the message receiving device 320. The message holding unit 313 according to this embodiment has substantially the same function as the message holding unit 113 according to the first embodiment described above except for the following point. The message holding unit 313 according to this embodiment holds the information (first authentication information A₀, data blocks (Mⱼ, Aⱼ) (1≦j≦n−1) and Mₙ) given by the authentication information adding unit 319. When the message holding unit 313 receives a message indicating the end of reception certification verification from the reception certification verifying unit 316, the held first authentication information A₀, data blocks (Mⱼ, Aⱼ) (1≦j≦n−1) and Mₙ are sequentially given to the send information generating unit 315.

(Send Notice Information Generating Unit 314)

The send notice information generating unit 314 is an operation part to generate send notice information configured by the first authentication code and the second authentication code for arbitrary data. The send notice information generating unit 314 has substantially the same function as the send notice information generating unit 114 according to the first embodiment described above except for the following points. The send notice information generating unit 314 according to this embodiment generates the first authentication code and the second authentication code for the first authentication information A₀ from the authentication information adding unit 319 and gives to the send information generating unit 315. In addition, the information (first authentication information A₀, data blocks (Mⱼ, Aⱼ) (1≦j≦n−1) and Mₙ) given by the message generating unit 311 is given to the message holding unit 313.

(Send Information Generating Unit 315)

The send information generating unit 315 is an operation part to generate the send information for the message receiving device 220 and has substantially the same function as the send information generating unit 115 according to the first embodiment described above except for the following points. The message holding unit 313 gives either the first authentication information A₀, the data block (Mⱼ, Aⱼ) or the Mₙ to the send information generating unit 315 according to this embodiment and the send information generating unit 315 generates the send information including the information respectively.

(Reception Certification Verifying Unit 316)

The reception certification verifying unit 316 is an operation part to verify whether the send information that has been sent is received by the message receiving device 320 to be a target and has substantially the same function as the reception certification verifying unit 116 according to the first embodiment described above except for the following points. When the reception certification verifying unit 316 according to this embodiment receives the send notice information (first and second authentication codes) from the send information generating unit 315, the reception certification verifying unit 316 performs substantially the same operation as the reception certification verifying unit 116 according to the first embodiment.

When the reception certification verifying unit 316 receives either the authentication code generation key Kₐ, the first authentication information A₀, the data block (Mⱼ, Aⱼ) or the Mₙ from the send information generating unit 315, the reception certification verifying unit 316 verifies whether the information has been correctly in the message receiving device 320 or not. More specifically, similarly to the case of the send notice information, the reception certification information is received from the message receiving device 320 and the reception certification information may be verified by using the authentication code generation key Kₐ, the first authentication information A₀, the data block (Mⱼ, Aⱼ) or the Mₙ. Or, it may be detected whether the send information has reached the message receiving device 320 or not with the sending of ACK/NACK from the message receiving device 320. When the send information does not reach, this may be resent by giving the authentication code generation key Kₐ, the first authentication information A₀, the data block (Mⱼ, Aⱼ) or the Mₙ to the sending unit 318. Here, the message indicating the end of reception certification verification is not sent when the reception is confirmed, which is different from the case of receipt acknowledgement of the send notice information described above.

(Authentication Information Adding Unit 319)

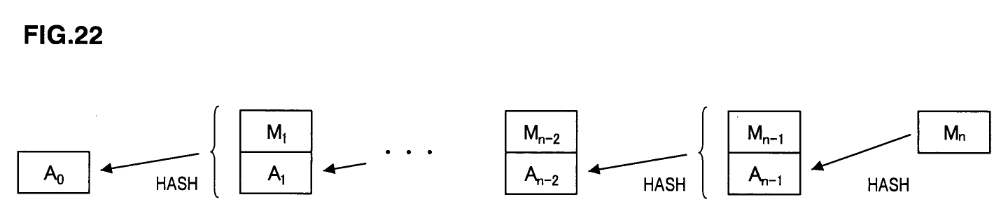

The authentication information adding unit 319 is an operation part to add the authentication information to each data block Mⱼ of the message M. The message generating unit 311 gives the data block Mⱼ (1≦j≦n) to the authentication information adding unit 319 and the authentication information adding unit 319 generates the authentication information for the data block Mⱼ. The authentication information may be, for example, a hash value generated from each data block. FIG. 22 is an explanatory diagram to describe the authentication information added to the data block by the authentication information adding unit 319. For example, as shown in FIG. 22, the authentication information adding unit 319 gives all of the generated information (the first authentication information A₀, the data block (Mⱼ, Aⱼ) and the Mₙ) to the message holding unit 313 and gives the first authentication information A₀ to the send notice information generating unit 314.

Each unit of the message sending device 310 according to this embodiment has been described, focusing the differences from each of the corresponding units in the first embodiment. It should be noted that the message generating unit 311, the authentication code generation key managing unit 312, the send notice information generating unit 314, the send information generating unit 315, the reception certification verifying unit 316, the receiving unit 317, the sending unit 318 and the authentication information adding unit 319 may be configured by the software where the program module capable of performing each function described above is installed in an information processor such as computer, or by the hardware such as processor capable of performing each function described above. The message holding unit 313 may be configured by, for example, various storage media such as semiconductor memory, optical disk, and magnetic disk.

(Message Receiving Device 320)

Next, there will be described the message receiving device 320 in the message authentication system according to this embodiment in reference to FIG. 21. FIG. 21 is a block diagram showing a schematic configuration of the message receiving device 320 according to this embodiment. As shown in FIG. 21, the message receiving device 320 according to this embodiment is configured by: a receiving unit 321; a reception certification information generating unit 322; an authentication code generation key verifying unit 323; a send notice information holding unit 324; a first authentication code authenticating unit 325; a message authenticating unit 326; a sending unit 327; and an authentication information authenticating unit 329.

Each unit of the message receiving device 320 according to this embodiment has substantially the same configuration as each unit of the message receiving device 120 according to the first embodiment. Hereafter, there will be described only the difference of the components except for the receiving unit 321, the authentication code generation key verifying unit 323 and the sending unit 327 in the message receiving device 320 according to this embodiment, from the components corresponding to each unit of the message receiving device 120 according to the first embodiment.

(Reception Certification Information Generating Unit 322)

The reception certification information generating unit 322 is an operation part to generate the reception certification information to certify that the send information is certainly received, for the message sending device 310. The reception certification information generating unit 322 according to this embodiment has substantially the same function as the reception certification information generating unit 122 according to the first embodiment described above except for the following points. The reception certification information generating unit 322 according to this embodiment gives the first authentication information A₀ to the authentication information authenticating unit 329 and gives the data blocks (Mⱼ, Aⱼ) (1≦j≦n−1) and Mₙ to the message authenticating unit 326. When the send information received from the receiving unit 321 is the information that does not include the first authentication information A₀, the reception certification information generating unit 322 may generate an ACK message or an NACK message to certify the certain reception of the information, for the message sending device 310, and may send the message via the sending unit 327.

(Send Notice Information Holding Unit 324)

The send notice information holding unit 324 is a memory unit to hold the send notice information (first and second authentication codes) received from the message sending device 310. The send notice information holding unit 324 has substantially the same function as the send notice information holding unit 124 according to the first embodiment described above except for the following point. The send notice information holding unit 324 according to this embodiment gives the held send notice information (first and second authentication codes) to the first authentication code authenticating unit 325 in the order of reception as the send notice information for the first authentication information A₀.

(First Authentication Code Authenticating Unit 325)

The first authentication code authenticating unit 325 is an operation part to verify whether the first authentication code included in the send notice information from the message sending device 310 is valid or not. The first authentication code authenticating unit 325 has substantially the same function as the first authentication code authenticating unit 125 according to the first embodiment described above except for the following point. The first and second authentication codes for the first authentication information A₀ are given to the first authentication code authenticating unit 325 according to this embodiment from the send notice information holding unit 324 in the order of the receptions.

(Message Authenticating Unit 326)

The message authenticating unit 326 is an operation part to authenticate whether the data block Mⱼ (1≦j≦n) from the reception certification information generating unit 322 is a valid data block Mⱼ generated by the message sending device or not. For example, the message authenticating unit 326 generates a hash value for the data block (M₁, A₁) given by the reception certification information generating unit 322 and judges whether the generated hash value matches the authentication information A₀ given by the authentication information authenticating unit 329. Thereby the data block (M₁, A₁) is authenticated. Similarly for example, a hash value for the data block (Mⱼ, Aⱼ) (2≦j≦n−1) given by the reception certification information generating unit 322 is generated and it is judged whether the generated hash value matches the authentication information Aⱼ₋₁ that has already been authenticated. Thereby the data block (Mⱼ, Aⱼ) is authenticated. Finally for example, a hash value for the data block Mₙ given by the reception certification information generating unit 322 is generated and it is judged whether the generated hash value matches the authentication information Aₙ₋₁ that has already been authenticated. Thereby the data block Mₙ is authenticated.

(Authentication Information Authenticating Unit 329)

The authentication information authenticating unit 329 is an operation part to authenticate that the first authentication information A₀ given by the reception certification information generating unit 322 is valid authentication information sent from the message sending device 310. For example, the authentication information authenticating unit 329 generates the authentication code for the first authentication information A₀ given by the reception certification information generating unit 322 by using the authentication code generation key Kₐ′ or Kₐ given by the first authentication code authenticating unit 325 and judges whether the generated authentication code matches the first authentication code given by the first authentication code authenticating unit 325. Thereby the first authentication information A₀ is authenticated. When the first authentication information A₀ is normally authenticated, the first authentication information A₀ is given to the message authenticating unit 326.

Each unit of the message receiving device 320 according to this embodiment has been described. It should be noted that the receiving unit 321, the reception certification information generating unit 322, the authentication code generation key verifying unit 323, the first authentication code authenticating unit 325, the message authenticating unit 326, the sending unit 327 and the authentication information authenticating unit 329 may be configured by the software where the program module capable of performing each function described above is installed in an information processor such as computer, or by the hardware such as processor capable of performing each function described above. The send notice information holding unit 324 may be configured by, for example, various storage media such as semiconductor memory, optical disk, and magnetic disk.

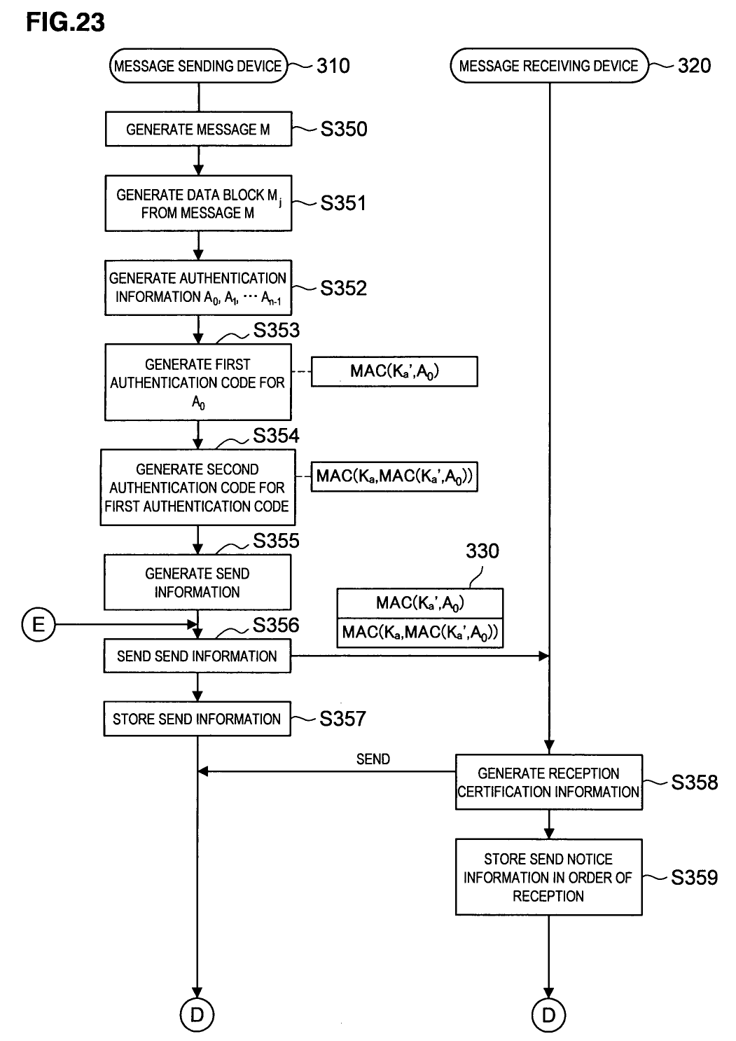

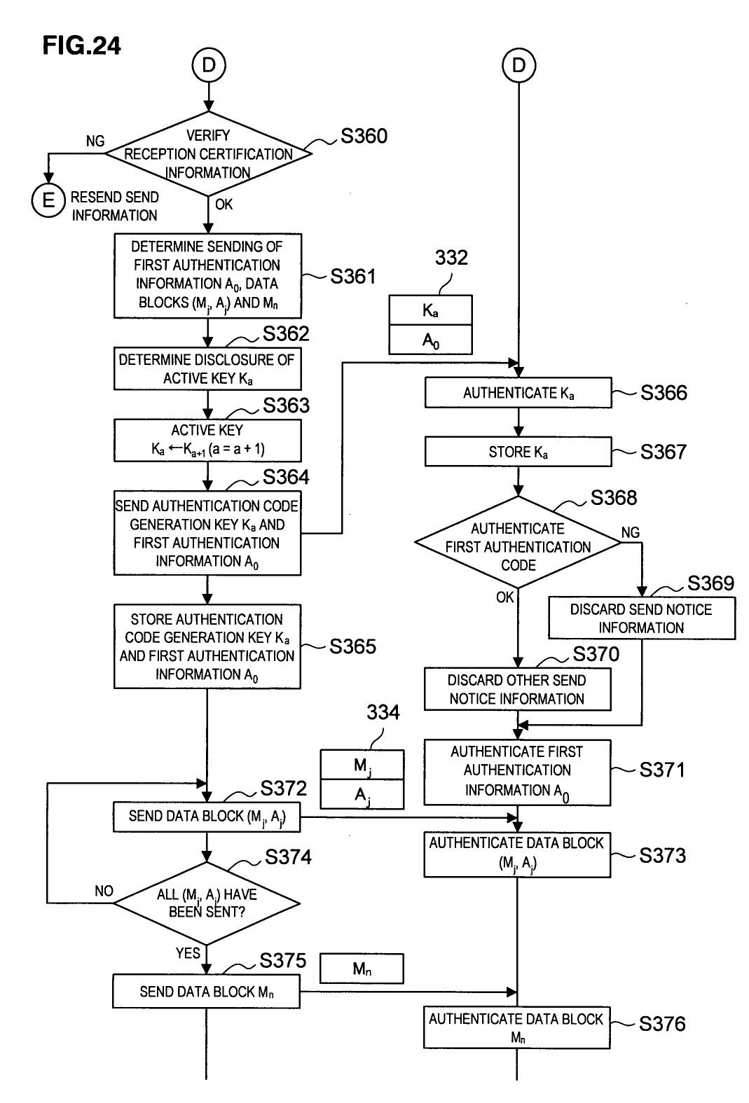

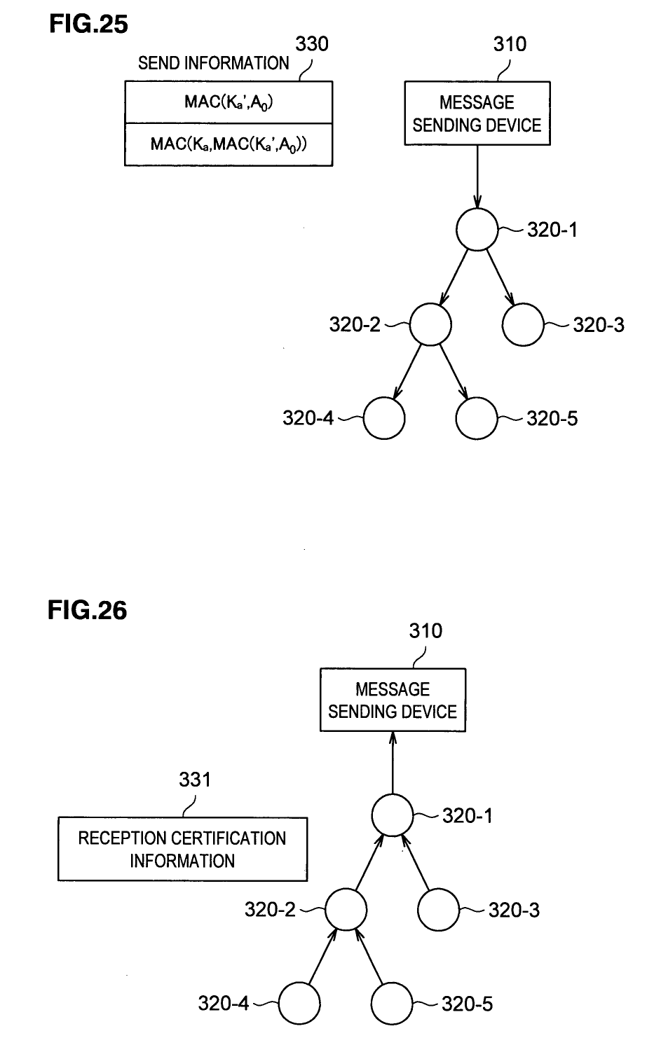

Next, there will be described an example of the message authentication process performed by the message authentication system according to this embodiment in reference to FIGS. 23-28. Here, FIGS. 23 and 24 are flowcharts showing flows of message authentication process according to this embodiment. FIG. 25 is an explanatory diagram showing a state in step S356 of the message authentication process according to this embodiment. Similarly, FIGS. 26, 27 and 28 are explanatory diagrams showing states in steps S358, S364 and S372.

First in step S350, the message M to be sent is generated in the message generating unit 311 in the message sending device 310. Next in step S351, the data block Mⱼ (1≦j≦n) is generated by dividing the message M. The generated data block Mⱼ is given to the authentication information adding unit 319.

In step S352, in the authentication information adding unit 319, authentication information Aⱼ (0≦j≦n−1) is generated. The authentication information Aⱼ is generated according to, for example, the process shown in FIG. 22. First, authentication information Aₙ₋₁ as the hash value of the last data block Mₙ is generated to be added to a data block Mₙ₋₁. Then authentication information Aₙ₋₂ as the hash value of the data block (Mₙ₋₁, Aₙ₋₁) with the authentication information Aₙ₋₁ added is generated to be added to a data block Mₙ₋₂. With the repetition of this operation, the data block (Mⱼ, Aⱼ) (1≦j≦n−1) and the authentication information A₀ are generated. Here, the authentication information A₀ generated last is referred to as first authentication information. The generated first authentication information A₀ is given to the send notice information generating unit 314. In addition, all of the generated information (authentication information A₀, data blocks (Mⱼ, Aⱼ) and Mₙ) is given to the message holding unit 313.

Next, the send notice information generating unit 314 generates the first authentication code for the first authentication information A₀ in step S353. Here, a first authentication code MAC (Kₐ′, M) is generated by using a value Kₐ′=G(Kₐ) calculated by applying the one-way function G to the present active key Kₐ that has not been disclosed to the network yet. The function G is assumed to be the function disclosed in the system.

Next in step S354, the second authentication code for the first authentication code MAC (Kₐ′, Mⱼ) (information to certificate the validity of the first authentication code) is generated. Here, a second authentication code MAC (Kₐ, MAC(Kₐ′, A₀)) is generated by using the present active key Kₐ. The generated first and second authentication codes are given to the send information generating unit 315.

Next in step S355, the send information including the first authentication code MAC (Kₐ′, A₀) and the second authentication code MAC (Kₐ, MAC(Kₐ′, A₀)) is generated in the send information generating unit 315.

Next in step S356 as shown in FIG. 25, send information 330 generated is sent to the message receiving device 320 via the sending unit 318. After the sending, the message sending device 310 stores the sent send information 330 in step S357.

The message receiving device 320 gives the send information 330 received via the receiving unit 321 to the reception certification information generating unit 322. The reception certification information generating unit 322 generates reception certification information 331 for the send information 330 in step S358, and sends to the message sending device 310 as shown in FIG. 26. Next in step S359, the send notice information included in the send information 330 is given to the send notice information holding unit 324 and stored in the order of reception.

In step S360, the message sending device 310 having received the reception certification information 331 from the message receiving device 320 in step S358 verifies the reception certification information 331 in the reception certification verifying unit 316. When the reception is confirmed by the verification, there proceeds to step S361 to determine the sending of the first authentication information A₀, the data blocks (Mⱼ, Aⱼ) (1≦j≦n−1) and the Mₙ. In step S362, it is determined that the authentication code generation key Kₐ used to generate the send notice information is disclosed to the network. In step S363, the active key Kₐ is updated to Kₐ₊₁.

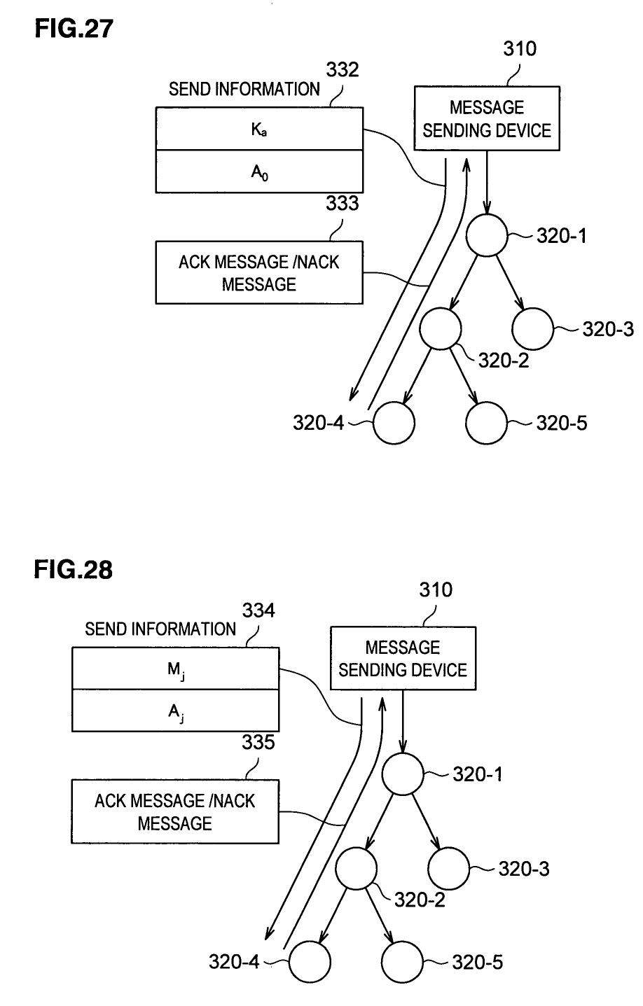

In step S364, as shown in FIG. 27, send information 332 including the first authentication information A₀ and the authentication code generation key Kₐ is sent from the message sending device 310 to the message receiving device 320. The message receiving device 320 may confirm the reception of the send information 332 and, as shown in FIG. 27, send an ACK/NACK message 333 to the message sending device 310. After the sending, the message sending device 310 stores the first authentication information A₀ and the authentication code generation key Kₐ in step S365.

The message receiving device 320 having received the first authentication information A₀ and the authentication code generation key Kₐ authenticates the authentication code generation key Kₐ in step S366. When the authentication code generation key Kₐ is normally authenticated, the authentication code generation key Kₐ is stored in step S367.

In step S368, the first authentication code included in the send notice information held in the send notice information holding unit 324 is authenticated. The send notice information holding unit 324 gives the held send notice information to the first authentication code authenticating unit 325 in the order of reception and the authentication is performed in the first authentication code authenticating unit 325. For example, the first authentication code authenticating unit 325 generates the authentication code for the first authentication code by using the authentication code generation key Kₐ to judge whether the generated authentication code matches the second authentication code or not. Thereby the first authentication code is authenticated.

When the authentication is not normally performed, there proceeds to step S369 and the send notice information is discarded. When the authentication is normally performed, there proceeds to step S370 and the send notice information other than the authenticated send notice information is discarded.

Next in step S371, in the authentication information authenticating unit 329, the first authentication information A₀ is authenticated. For example, the authentication information authenticating unit 329 generates the authentication code for the first authentication information A₀ from the reception certification information generating unit 322 by using the authentication code generation key Kₐ′ or Kₐ from the first authentication code authenticating unit 325 and judges whether the generated authentication code matches the first authentication code from the first authentication code authenticating unit 325. Thereby the first authentication information A₀ is authenticated. The authenticated first authentication information A₀ is given to the message authenticating unit 326.

In step S372 as shown in FIG. 28, on the other hand, send information 334 including the data block (Mⱼ, Aⱼ) (1≦j≦n−1) is sent from the message sending device 310 to the message receiving device 320. In step S373 the message receiving device 320 having received the data block (Mⱼ, Aⱼ) authenticates the data block (Mⱼ, Aⱼ) in the message authenticating unit. Hereafter, the processes of steps S372 and S373 are repeated until the message sending device 310 sends all data blocks (Mⱼ, Aⱼ) (1≦j≦n−1).

The data block (Mⱼ, Aⱼ) is authenticated by, for example, generating a hash value for the data block (M₁, A₁) given by the reception certification information generating unit 322 and judging whether the generated hash value matches the authentication information A₀ given by the authentication information authenticating unit 329. Similarly for example, a hash value for the data block (Mⱼ, Aⱼ) (2≦j≦n−1) given by the reception certification information generating unit 322 is generated and it is judged whether the generated hash value matches the authentication information Aⱼ₋₁ that has already been authenticated. Thereby the data block (Mⱼ, Aⱼ) is authenticated.

In step S374, when it is judged that all data blocks (Mⱼ, Aⱼ)(1≦j≦n−1) have been sent in the message sending device 310, there proceeds to step S375 to send the last data block Mₙ to the message receiving device 320.

When the data block Mₙ is received in the message receiving device 320, the message authenticating unit 326 authenticates the data block Mₙ. For example, the message authenticating unit 326 generates a hash value for the data block Mₙ given by the reception certification information generating unit 322 and judges whether the generated hash value matches the authentication information Aₙ₋₁ that has already been authenticated. Thereby the data block Mₙ is authenticated.

An example of the message authentication process performed by the message authentication system according to this embodiment has been described.

According to the configuration of this embodiment, the message sending device generates the send notice information for the first packet while the message receiving device regards the authentication of the first packet as a commitment. Thereby the packet to be received subsequently is authenticated. With such a configuration, the size of data block of the message that can be included in one packet can be increased, compared to the first embodiment in which each packet including the send notice information is sent. In addition, even when not all data blocks have been received, the authentication can be performed for each data block by regarding the authentication of the previous data block as a commitment, compared to the second embodiment in which the authentication is performed for the message restored from all data blocks.

Although the preferred embodiment of the present invention has been described referring to the accompanying drawings, the present invention is not restricted to such examples. It is evident to those skilled in the art that the present invention may be modified or changed within a technical philosophy thereof and it is understood that naturally these belong to the technical philosophy of the present invention.

For example, when the authentication cannot be performed in the message receiving device, an error message may be sent to the message sending device via the sending unit in the above second and third embodiments.

In the above third embodiment, the authentication information adding unit may build a Merkle authentication tree with the hash value of the data block Mⱼ (1≦j≦n) as a leaf and may set the information of a child at the location other than the route from the leaf to a root as the first authentication information A₀, among the children of all nodes existing at the locations from the leaf corresponding to the data block Mⱼ to the root. Here, the first authentication information A₀ may be regarded as the value of the root of the Merkle authentication tree.

Although there has been described the case of authenticating one message in one authentication code generation key in each of the above embodiments so as to simplify the description, the present invention is not restricted to this example. For example, a plurality of messages may be authenticated in one authentication code generation key.

Although there has been described that the authentication code generation key is generated by using the key of the authentication code generation key chain in each of the above embodiments, the present invention is not restricted to this example. For example, the information derived from each key of the authentication code generation key chain may be used for the authentication code generation key to grasp the method of creating the information on both sides of the message sending device and the message receiving device.

Although there is not specified about an information relaying unit that relays information in multihop communication in the description of the message receiving device in each of the above embodiments, the message receiving device is implicitly provided with the information relaying unit to give the information from the receiving unit to the sending unit and to transfer to the device at the destination of relaying when the message receiving device is a relaying device in multihop communication environment.

What is claimed is:

1. A message authentication system having a message sending device that sends a message and a message receiving device that authenticates the sent message in a multihop network, wherein,
the message sending device comprises:
an authentication code generation key managing unit that manages an authentication code generation key chain including two or more authentication code generation keys used for message authentication;
a send notice information generating unit that generates send notice information configured by a first authentication code to certify the validity of the message and a second authentication code to certify the validity of the first authentication code, by using the authentication code generation key; and
a sending unit that sends the send notice information to the message receiving device and that sends the message and the authentication code generation key after authenticating reception certification information sent from the message receiving device in accordance with the send notice information,
and wherein,
the message receiving device comprises:
a reception certification information generating unit that generates the reception certification information to certify the receiving of the send notice information;
a first authentication code authenticating unit that authenticates the first authentication code by using the second authentication code and the authentication code generation key sent from the message sending device; and
a message authenticating unit that authenticates the message received from the message sending device by using the authenticated first authentication code and the authentication code generation key.

2. The message authentication system according to claim 1, wherein the authentication code generation key managing unit generates each authentication code generation key by increasing sequentially the number of performing disclosed one-way function for an arbitrary value and discloses each authentication code generation key to the message receiving device inversely with the order of being generated.

3. The message authentication system according to claim 2, wherein the send notice information generating unit generates the first authentication code by using either the authentication code generation key that is not disclosed or a value generated by applying a predetermined one-way function disclosed to the authentication code generation key that is not disclosed.

4. The message authentication system according to claim 2, wherein the send notice information generating unit generates the second authentication code by using either the authentication code generation key that is not disclosed or a value generated by applying a predetermined one-way function disclosed to the authentication code generation key that is not disclosed, and by using the first authentication code.

5. The message authentication system according to claim 2, wherein the message receiving device verifies whether the received authentication code generation key is disclosed or not and authenticates the first authentication code by using the authentication code generation key when the authentication code generation key is not disclosed.

6. The message authentication system according to claim 1, wherein:
the message receiving device further comprises a send notice information holding unit that holds the received send notice information in the order of reception until the authentication code generation key is sent from the message sending device; and
the first authentication code authenticating unit authenticates the first authentication code included in the send notice information held in the send notice information holding unit, discards other send notice information held in the send notice information holding unit in the case of authenticating, and discards the send notice information in the case of not authenticating.

7. The message authentication system according to claim 1, wherein the message sending device sends the message after dividing into two or more data blocks.

8. The message authentication system according to claim 7, wherein:
the send notice information generating unit generates the send notice information corresponding to each of the data blocks; and
the message authenticating unit authenticates each of the data blocks by using the send notice information corresponding to each of the data blocks.

9. The message authentication system according to claim 7, wherein:
the send notice information generating unit generates the send notice information corresponding to the message before divided; and
the message authenticating unit restores the message by combining all of the data blocks of the message and authenticates the restored message by using the send notice information.

10. The message authentication system according to claim 7, wherein:
the message sending device further comprises an authentication information adding unit that adds authentication information to each of the data blocks; and
the authentication information adding unit generates the authentication information by applying a predetermined and disclosed one-way function to an arbitrary data block, adds the generated authentication information to another data block, applies the one-way function to the data block with the authentication information added and repeats these operations to generate the authentication information.

11. The message authentication system according to claim 10, wherein the one-way function is a hash function.

12. The message authentication system according to claim 10, wherein:
the send notice information generating unit generates the send notice information corresponding to first authentication information as the authentication information finally generated;
the sending unit sends the first authentication information and the authentication code generation key to the message receiving device before sending the data blocks and sends the data blocks after receiving a notification of the authentication of the first authentication information from the message receiving device; and
the message receiving device further comprises an authentication information authenticating unit that authenticates the first authentication information by using the send notice information and the authentication code generation key.

13. The message authentication system according to claim 10, wherein:
the sending unit sends the data blocks inversely with the order of generating the authentication information; and
the message authenticating unit authenticates the data blocks by using the authentication information included in the data blocks received immediately before the data blocks.

14. A message authentication method that authenticates a message sent from a message sending device by a multihop network in a message receiving device, the message authentication method comprising:
a message generating step of generating the message sent from the message sending device to the message receiving device;
an authentication code generation key generating step of generating an authentication code generation key chain including two or more authentication code generation keys used for message authentication in the message sending device;
a send notice information generating step of generating send notice information configured by a first authentication code to certify the validity of the message and a second authentication code to certify the validity of the first authentication code, by using the authentication code generation key in the message sending device;
a send notice information sending step of sending the send notice information from the message sending device to the message receiving device;
a reception certification information generating step of generating the reception certification information to certify the receiving of the send notice information in the message receiving device;
a reception certification information authenticating step of authenticating, on the message sending device's side, the reception certification information sent from the message receiving device;
an authentication code generation key sending step of sending the authentication code generation key from the message sending device to the message receiving device;
a message sending step of sending the message from the message sending device to the message receiving device;
a first authentication code authenticating step of authenticating, on the message receiving device's side, the first authentication code by using the second authentication code and the authentication code generation key sent from the message sending device; and
a message authenticating step of authenticating the message that the message receiving device has received from the message sending device by using the authenticated first authentication code and the authentication code generation key.

15. The message authentication method according to claim 14, wherein:
the send notice information generating step generates each authentication code generation key by increasing sequentially the number of performing disclosed one-way function for an arbitrary value disclosed; and
each authentication code generation key included in the authentication code generation key chain is disclosed to the message receiving device inversely with the order of being generated.

16. The message authentication method according to claim 15, wherein, in the send notice information generating step, there is generated the first authentication code by using either the authentication code generation key that is not disclosed or a value generated by applying a predetermined one-way function disclosed to the authentication code generation key that is not disclosed.

17. The message authentication method according to claim 15, wherein, in the send notice information generating step, there is generated the second authentication code by using either the authentication code generation key that is not disclosed or a value generated by applying a predetermined one-way function disclosed to the authentication code generation key that is not disclosed, and by using the first authentication code.

18. The message authentication method according to claim 15, wherein the message receiving device verifies whether the received authentication code generation key is disclosed or not before the first authentication code authenticating step and authenticates the first authentication code by using the authentication code generation key when the authentication code generation key is not disclosed.

19. The message authentication method according to claim 14, wherein:
the message receiving device holds the received send notice information in the order of reception until the authentication code generation key is sent from the message sending device; and
there is authenticated, in the first authentication code authenticating step, the first authentication code included in the held send notice information in the order of reception, discarded other send notice information in the case of authenticating, and discarded the send notice information in the case of not authenticating.

20. The message authentication method according to claim 14, wherein, in the message generating step, the message is generated by being dividing into two or more data blocks.

21. The message authentication method according to claim 20, wherein:
there is generated, in the send notice information generating step, the send notice information corresponding to each of the data blocks; and
there is authenticated, in the message authenticating step, each of the data blocks by using the send notice information corresponding to each of the data blocks.

22. The message authentication method according to claim 20, wherein:
there is generated, in the send notice information generating step, the send notice information corresponding to the message before divided;
there is further comprised the step of restoring the message by combining all of the data blocks of the message before the message authenticating step; and
there is authenticated, in the message authenticating step, the restored message by using the send notice information.

23. The message authentication method according to claim 20, wherein:
there is further comprised an authentication information adding step of adding authentication information to each of the data blocks through the repetition of adding the authentication information generated by applying a predetermined and disclosed one-way function to an arbitrary data block before the send notice information generating step, to another data block, and applying the one-way function to the data block with the authentication information added.

24. The message authentication method according to claim 23, wherein the one-way function is a hash function.

25. The message authentication method according to claim 23, wherein:
there is generated, in the send notice information generating step, the send notice information corresponding to first authentication information as the authentication information finally generated; and
before the message sending step,
there is further comprised the step of sending the first authentication information and the authentication code generation key to the message receiving device, and
there is further comprised an authentication information authenticating step of authenticating the first authentication information by using the send notice information and the authentication code generation key.

26. The message authentication method according to claim 23, wherein:
in the message sending step the data blocks are sent inversely with the order of generating the authentication information; and
in the message authenticating step the data blocks are authenticated by using the authentication information included in the data blocks received immediately before the data blocks.
